(19) United States
(12) Patent Application Publication
(10) Pub. No.: US 2025/0200501 A1
(43) Pub. Date: Jun. 19, 2025

(54) CARGO TRANSPORTATION METHOD, DEVICE, EQUIPMENT, AND STORAGE MEDIUM THEREOF

(71) Applicant: WUHAN UNIVERSITY OF TECHNOLOGY, WUHAN (CN)

(72) Inventor: HONGCHU YU, WUHAN (CN)

(21) Appl. No.: 19/067,982

(22) Filed: Mar. 2, 2025

Related U.S. Application Data
(63) Continuation-in-part of application No. 18/750,199, filed on Jun. 21, 2024.

(30) Foreign Application Priority Data
Oct. 17, 2023 (CN) 202311343072.1

(51) Int. Cl. G06Q 10/0835; G06Q 10/047; G06Q 10/0631; G06Q 10/0831; G06Q 50/40

(52) U.S. Cl. CPC G06Q 10/08355; G06Q 10/047; G06Q 10/06311; G06Q 10/0831; G06Q 50/40

(57) ABSTRACT

A cargo transportation method, a device, an equipment, and a storage medium thereof are provided. The cargo transportation method includes steps receiving transport request information, wherein the transport request information at least includes departure port information and destination port information; obtaining shipping data from different shipping companies, classifying the shipping data based on preset information categories, and obtaining shipping route related data, ship related data, and cargo related data; constructing a shipping schedule related nine-intersection model based on the shipping route related data; determining at least two target ships based on the transport request information, the shipping schedule related nine-intersection model, the cargo related data, and ship related data; and sending instruction information to the at least two target ships, wherein the instruction information is configured to control the at least two target ships to transport cargo from a departure port to a destination port.

### TECHNICAL FIELD

The disclosure relates to the technical field of water transportation, in particular to a cargo transportation method, a device, an equipment, and a storage medium thereof.

### BACKGROUND

The transportation cost of large ships per unit of cargo is generally much lower than that of small ships. When the production locations of each batch of scattered cargo are relatively concentrated in a production area, the sales locations are also relatively concentrated in a sales area, and the distance between the production area and the sales area is relatively far, developing a reasonable plan to transport scattered cargo from different origins can effectively improve economic benefits.

However, in existing technology, consolidation is carried out by consolidating cargo on the same shipping company's route, and consolidation cannot be achieved between different shipping companies.

Therefore, there is an urgent need for a cargo transportation method, device, equipment, and storage medium to solve the cargo consolidation between different shipping enterprises.

### SUMMARY

The purpose of the present disclosure is to provide a cargo transportation method, a device, an equipment, and a storage medium thereof to solve the technical problem in the prior art to achieve cargo consolidation between different shipping enterprises in existing technologies.

In order to solve the above technical problems, in a first aspect, the present disclosure provides a cargo transportation method. The cargo transportation method is applied to a computer equipment. The computer equipment is at least in communication connection with electronic devices. Each of electronic devices is disposed on a corresponding target ship. The cargo transportation method comprising steps:
receiving transport request information, wherein the transport request information at least comprises departure port information and destination port information;
obtaining shipping data from different shipping companies, classifying the shipping data based on preset information categories, and obtaining shipping route related data, ship related data, and cargo related data; wherein the shipping route related data comprises shipping company code, route code, route departure port, route stopping ports, route destination port, departure time at departure port, arrival time at route stopping ports, and destination port arrival time; the ship related data comprises ship identification code, ship cargo type, and ship deadweight; the cargo related data comprises cargo type and cargo capacity;
constructing a shipping schedule related nine-intersection model based on the shipping route related data;
determining at least two target ships based on the transport request information, the shipping schedule related nine-intersection model, the cargo related data, and ship related data; and
sending instruction information to the at least two target ships, wherein the instruction information is configured to control the at least two target ships to transport cargo from a departure port to a destination port.

The shipping schedule related nine-intersection model comprises nine-intersection model of route and nine-intersection model of time.

The step of determining the at least two target ships based on the transport request information, the shipping schedule related nine-intersection model, the cargo related data, and ship related data comprises:
determining a first route and a second route based on the transport request information, and determining whether there is a consolidated shipping segment for cargo transportation between the first route and the second route based on the nine-intersection model of route;
when there is the consolidated shipping segment, determining whether the consolidated shipping segment meets the time condition based on the nine-intersection model of time;
when the consolidated shipping segment meets a time condition, determining whether there are the goods of the same cargo type in the consolidated shipping segment based on the cargo related data;
when there are the goods of the same cargo type in the consolidated shipping segment, determining whether the consolidated shipping segment meets the requirements for cargo logistics loading based on the ship related data; and
when the consolidated shipping segment meets requirements for cargo logistics loading, determining the at least two target ships based on the consolidated shipping segment.

The nine-intersection model of route R₉(SLᵢⱼ, SL_{pq}) is:

$$\{ \begin{matrix}{Port}_{ij 1} {∩ Port}_{pq 1} & {Port}_{ij 1} ⋂ \partial {Port}_{pq} & {Port}_{ij 1} ⋂ {Port}_{pqn} \\ \partial {Port}_{ij} {∩ Port}_{pq 1} & \partial {Port}_{ij} ∩ \partial {Port}_{pq} & \partial {Port}_{ij} {∩ Port}_{pqn} \\ {Port}_{ijn} {∩ Port}_{pq 1} & {Port}_{ijn} ∩ \partial {Port}_{pq} & {Port}_{ijn} {∩ Port}_{pqn}\end{matrix} \}$$

Portᵢⱼ₁ represents the departure port of route SLᵢⱼ, ∂Portᵢⱼ represents the intermediate stopping ports of route SLᵢⱼ, Portᵢⱼₙ represents the destination port of route SLᵢⱼ; Port_{pq1} represents the departure port of route SL_{pq}, ∂Port_{pq} represents the stopping ports of route SLpq, Port_{pqn} represents the destination port of the SL_{pq} route.

The nine-intersection model of time R_{g}(Tᵢⱼ, T_{pq}) is:

$${R}_{9} ( {T}_{ij} , {T}_{pq} ) = \{ \begin{matrix}{T}_{ij 1} ∩ {T}_{pq 1} {T}_{ij 1} ∩ \partial {T}_{pq} {T}_{ij 1} ∩ {T}_{pqn} \\ \partial {T}_{ij} ∩ {T}_{pq 1} \partial {T}_{ij} ∩ \partial {T}_{pq} \partial {T}_{ij} ∩ {T}_{pqn} \\ {T}_{ijn} ∩ {T}_{pq 1} {T}_{ijn} ∩ \partial {T}_{pq} {T}_{ijn} ∩ {T}_{pqn}\end{matrix} \}$$

Tᵢⱼ₁ represents the department time of the operating fleet of route SLᵢⱼ, ∂Tᵢⱼ represents the stopping time at each intermediate port of the operating fleet of route SLᵢⱼ, Tᵢⱼₙ represents the final port stop time of the operating fleet of route SLᵢⱼ; T_{pq1} represents the departure time of the operating fleet of route SL_{pq}, and ∂T_{pq} represents the stopping time of the operating fleet of route SL_{pq} at each intermediate port, T_{pqn} represents the final port stop time of the operating fleet on route SL_{pq}.

In one optional embodiment, the first route comprises a first departure port and a first destination port. The second route comprises a second departure port and a second destination port.

The step of determining whether there is the consolidated shipping segment for cargo transportation between the first route and the second route based on the nine-intersection model of route comprises:
determining the first departure port and second departure port based on the transport request information and the nine-intersection model of route, determining whether the first departure port and second departure port are the same based on the nine-intersection model of route, and determining whether the first destination port and second destination port are the same based on the nine-intersection model of route; and
when the first department port and the second department port are the same, and the first destination port and the second destination port are also the same, determining that there is the consolidated shipping segment between the first route and the second route.

In one optional embodiment, the first route comprises the first departure port, the first destination port, and at least one first stopping port. The second route comprises the second departure port, the second destination port, and at least one second stopping port.

The at least one first stopping port comprises one or more first stopping ports, and the at least one second stopping port comprises one or more second stopping ports;

The step of determining whether there is the consolidated shipping segment for cargo transportation between the first route and the second route based on the nine-intersection model of route comprises:
determining the first route and the second route base on the transport request information, determining whether the first departure port and second departure port are the same based on the nine-intersection model of route, and determining whether the first destination port and the second destination port are the same based on the nine-intersection model of route;
when the first departure port and the second departure port are the same, and the first destination port and the second destination port are the same, determining that there is the consolidated shipping segment for cargo transportation between the first route and the second route;
when the first departure port and the second departure port are the same, the first destination port and the second destination port are different, and at least one of the at least one first stopping port is the same as at least one of the least one second stopping port, determining that there is the consolidated shipping segment for cargo transportation between the first route and the second route;
when the first departure port and the second departure port are the same, the first destination port is different from the second destination port, and the at least one first stopping port is completely different from the at least one second stopping port, determining whether there is an intersection between the first destination port and the at least one second stopping port, or whether there is an intersection between the second destination port and the at least one first stopping port based on the nine-intersection model of route;
when there is the intersection between the first destination port and the at least one second stopping port, or when there is the intersection between the second destination port and the at least one first stopping port, determining that there is the consolidated shipping segment for cargo transportation between the first route and the second route;
when the first departure port and the second departure port are different, the first destination port is the same as the second destination port, and at least one of the at least one first stopping port is the same as at least one of the least one second stopping port, there is the consolidated shipping segment for cargo transportation between the first route and the second route; and
when the first departure port and the second departure port are different, the first destination port and the second destination port are different, the at least one first stopping port comprises at least two first stopping ports, the at least one second stopping port comprises at least two second stopping ports, and at least two of the first stopping ports are the same as at least two of the at least two stopping ports, determining that there is the consolidated shipping segment for cargo transportation between the first route and the second route.

In one optional embodiment, the consolidated shipping segment comprises a departure port for consolidated shipment and an arrival port for consolidated shipment.

The step of determining whether the consolidated shipping segment meets the time condition based on the nine-intersection model of time comprises:
obtaining the first departure time of the first route at the departure port for consolidated shipment and the first arrival time of the first route at the arrival port for consolidated shipment;
obtaining the second departure time of the second route at the departure port for consolidated shipment and the second arrival time of the second route at the arrival port for consolidated shipment;
based on the nine-intersection model of time, determining whether there is a time intersection between the first departure time and the second departure time, as well as whether there is a time intersection between the first arrival time and the second arrival time;
when there is a time intersection between the first departure time and the second departure time, and there is a time intersection between the first arrival time and the second arrival time, the consolidated shipping segment satisfies the time condition;
when there is no time intersection between the first departure time and the second departure time, and/or when there is no time intersection between the first arrival time and the second arrival time, determining whether the time difference between the first departure time and second departure time and the time difference between the first arrival time and the second arrival time are both less than a preset time difference; and
when the time difference between the first departure time and the second departure time and the time difference between the first arrival time and the second arrival time are both less than the present time difference, the consolidated shipping segment satisfies the time condition.

In one optional embodiment, the consolidated shipping segment comprises a first vessel in the first route and a second vessel in the second route.

The step of determining whether the consolidated shipping segment meets the requirements for cargo logistics loading based on the ship related data comprises:
determining the cargo capacity of the first vessel, the ship deadweight of the first vessel, the cargo capacity of the second vessel, and the ship deadweight of the second vessel based on the ship related data;
determining whether the ship deadweight of the first vessel or the ship deadweight of the second vessel is greater than the sum of the cargo capacity of the first vessel and the cargo capacity of the second vessel; and
when the ship deadweight of the first vessel or the ship deadweight of the second vessel is greater than the sum of the cargo capacity of the first vessel and the cargo capacity of the second vessel, determining that the consolidated shipping segment meets the requirements for cargo logistics loading.

In a second aspect, the present disclosure provides a computer equipment. The computer equipment comprises a memory and a processor. The memory is configured to store a program. The processor is coupled with the memory and is configured to execute the program stored in the memory to implement the steps of the cargo transportation method mentioned above.

In a third aspect, the present disclosure provides a computer-readable storage medium. The computer-readable storage medium comprises a program or an instruction stored therein. The program or the instruction is readable by a computer equipment. The program or the instruction is executed by a processor of the computer equipment to implement the steps of the cargo transportation method mentioned above.

Compared with the prior arts, the beneficial effect of the present disclosure is: by obtaining shipping data from different shipping companies and categorizing them based on preset information categories, shipping route related data, ship related data, and cargo related data are obtained to achieve mixed and unified processing of shipping data from different shipping companies. Then, constructing a shipping schedule related nine-intersection model, and determining the shipping data consolidation plan based on the shipping schedule related nine-intersection model, the cargo related data, and the ship related data. This achieves consolidation for different shipping companies, saves operating costs for shipping companies, and improves their efficiency. Moreover, through consolidated transportation, multiple shipping companies can share transportation vessels and other facilities, helping small shipping companies overcome the problem of insufficient transportation capacity, jointly bear logistics costs, avoid empty waste of freight facilities and containers, and improve resource utilization efficiency. Shipping companies can reduce the number of vessel trips and lower the risk of traffic accidents through consolidated transportation. Consolidated transportation can reduce the number of trucks or ships operate, reduce fuel consumption and carbon emissions, and help promote sustainable development and green water logistics.

Furthermore, based on the shipping schedule related nine-intersection model, the topological relationship between routes can be determined. The advantage of this model is that it can analyze a single route of each of the companies and simultaneously analyze the time windows and topological relationships of multiple routes for multi-route consolidation, thereby improving the efficiency of consolidation for shipping companies. This not only saves transportation costs but also solves the problem of insufficient transportation capacity.

The calculation method is simple and the computational complexity is small, which can improve the generation efficiency of consolidation plans.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1A is a schematic diagram of an application environment of a cargo transportation method provided by the present disclosure.

FIG. 1B is a flowchart of the cargo transportation method according to one embodiment of the present disclosure.

FIG. 2 is a flowchart of step S103 shown in FIG. 1A according to one embodiment of the present disclosure.

FIG. 3 is a flowchart of step S201 in FIG. 2 according to one embodiment of the present disclosure.

FIG. 4 is a flowchart of step S201 in FIG. 2 according to another embodiment of the present disclosure.

FIG. 5 is a flowchart of step S202 in FIG. 2 according to one embodiment of the present disclosure.

FIG. 6 is a flowchart of step S204 in FIG. 2 according to one embodiment of the present disclosure.

FIG. 7 is a schematic diagram of the first embodiment of the cargo transportation method according to one embodiment of the present disclosure.

FIG. 8 is a schematic diagram of the second embodiment of the cargo transportation method according to one embodiment of the present disclosure.

FIG. 9 is a schematic diagram of the third embodiment of the cargo transportation method according to one embodiment of the present disclosure.

FIG. 10 is a schematic diagram of the fourth embodiment of the cargo transportation method according to one embodiment of the present disclosure.

FIG. 11 is a schematic diagram of the fifth embodiment of the cargo transportation method according to one embodiment of the present disclosure.

FIG. 12 is a schematic diagram of the sixth embodiment of the cargo transportation method according to one embodiment of the present disclosure.

FIG. 13 is a schematic diagram of the seventh embodiment of the cargo transportation method according to one embodiment of the present disclosure.

FIG. 14 is a schematic diagram of the eighth embodiment of the cargo transportation method according to one embodiment of the present disclosure.

FIG. 15 is a schematic diagram of the ninth embodiment of the cargo transportation method according to one embodiment of the present disclosure.

FIG. 16 is a schematic diagram of the tenth embodiment of the cargo transportation method according to one embodiment of the present disclosure.

FIG. 17 is a structural schematic diagram of a cargo transportation device according to one embodiment of the present disclosure.

FIG. 18 is a structural schematic diagram of a computer equipment according to one embodiment of the present disclosure.

### DETAILED DESCRIPTION OF PREFERRED EMBODIMENTS

The technical solutions in the embodiments of the application will be described clearly and completely in combination with the drawings in the embodiments of the application.

The following will provide a clear and complete description of the technical solution in the present disclosure, in conjunction with the accompanying drawings. Obviously, the described embodiments are only a partial embodiment of the present disclosure, not the entire embodiment. Based on the embodiments in the present disclosure, all other embodiments obtained by those skilled in the art without creative labor fall within the scope of the present disclosure protection.

It should be understood that the schematic drawings are not drawn to the actual scale. The flowchart used in the present disclosure illustrates the operations implemented based on some embodiments of the present disclosure. It should be understood that the operations in a flowchart can be implemented out of sequence, and steps without logical contextual relationships can be reversed or implemented simultaneously. In addition, technical personnel in this field can add one or more other operations to the flowchart under the guidance of the present disclosure content, and can also remove one or more operations from the flowchart.

Some of the block diagrams shown in the attached diagram are functional entities and may not necessarily correspond to physically or logically independent entities. These functional entities can be implemented in software form, or in one or more hardware modules or integrated circuits, or in different networks and/or processor systems and/or microcontroller systems.

Referring to “embodiment” in this article means that specific features, structures, or features described in conjunction with the embodiment may be included in at least one embodiment of the present disclosure. The phrase appearing in various positions in the specification does not necessarily refer to the same embodiment, nor is it an independent or alternative embodiment that is mutually exclusive with other embodiments. Technicians in this field explicitly and implicitly understand that the embodiments described in this article can be combined with other embodiments.

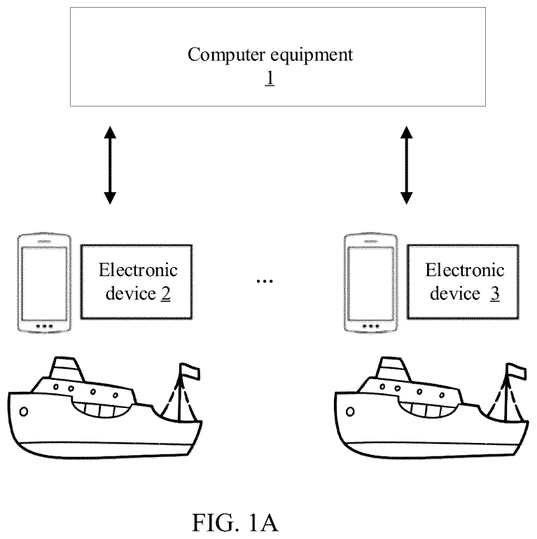

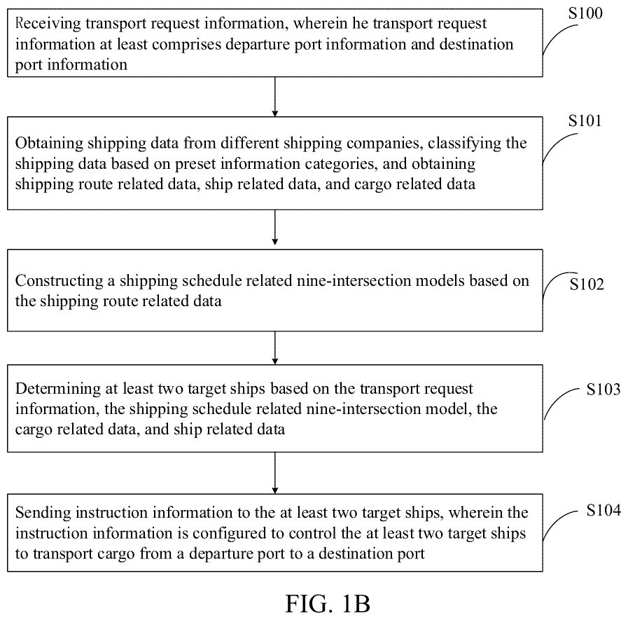

In order to at least solve problems discussed in the prior art, the present disclosure provides a cargo transportation method that is able to dispatch at least two target ships to transport cargo. FIG. 1A is a schematic diagram of an application environment of the cargo transportation method of the present disclosure. Operations shown in FIG. 1A and presented below are for illustrative purposes. The cargo transportation method is applied to a computer equipment 1. The computer equipment 1 may be implemented on or as various devices such as a mobile phone, a tablet computer, a server, a computer, a wearable device (smart watch), etc. The above computer equipment 1 comprise appropriate software (e.g., platform program, etc.) installed therein and/or hardware (e.g., wired, wireless connection, etc.) installed therein to access other devices.

In some embodiments of the present disclosure, a computer equipment 1 is in communication with electronic devices (i.e., an electronic device 2 and an electronic device 3 shown in FIG. 1A). The electronic devices may include devices such as controllers on ships, mobile phones, tablet computers, onboard computers, wearable devices (smart watches), etc. The electronic devices are disposed in ships of different shipping companies. The computer equipment 1 may send data to or receive data from the electronic devices. When the electronic devices are the controllers on the ships, and when the electronic devices receive instruction information sent by the computer equipment 1, corresponding ships are controlled to sail according to the instruction information. When the electronic devices are the mobile phones, the tablet computers, the onboard computers, or the wearable devices (e.g., smart watches), the electronic devices are in communication with other electronic devices controlling the ships. For example, when the electronic devices are the mobile phones, the mobile phones are respectively in communication with the electronic devices controlling the ships, and when the mobile phones receive the instruction information from the computer equipment 1, the instruction information is sent to the electronic devices controlling the ships, thereby controlling the ships to sail according to the instruction information.

In some embodiments, the computer equipment 1 realizes online information or a service platform. The service platform may receive transport request information, determine target ships that meets the transport request information, and send instruction information to the target ships to instruct the target ships to transport the cargo. For example, a user may use an electronic device (e.g., the mobile phone with a software application associated with the service platform) to request that a ship arranged by the service platform transport the cargo. After receiving the transport request information and determining the target ships according to the transport request information, the computer equipment 1 may send the instruction information to the electronic devices on the target ships, and control the target ships to transport the cargo through the electronic devices.

Embodiments of the present disclosure provides a cargo transportation method, device, equipment, and storage medium thereof, which are explained separately below.

FIG. 1B is a flowchart of the cargo transportation method provided by one embodiment of the present disclosure. As shown in FIG. 1, the cargo transportation method comprises steps S100-S104.

The step S100 comprises receiving transport request information. The transport request information at least comprises departure port information and destination port information.

In one embodiment of the present disclosure, when the user needs to transport the cargo from the departure port to the destination port, the transport request information is sent through a corresponding electronic device. Then, the computer equipment receives the transport request information. The transport request information includes information such as a cargo type, a cargo weight, shipment time, arrival time, an address of the departure port, and an address of the destination port.

In some embodiments, the transport request information further includes sender information and recipient information. The sender information includes information such as a name and a phone number of the sender; and the recipient information includes information such as a name and a phone number of the recipient.

The step S101 comprises obtaining shipping data from different shipping companies, classifying the shipping data based on preset information categories, and obtaining shipping route related data, ship related data, and cargo related data.

In the embodiment of the present disclosure, the shipping route related data comprises shipping company code, route code, route departure port, route stopping ports, route destination port, departure time, arrival time at each route stopping port, and destination port arrival time. The ship related data comprises ship identification code, ship cargo type, and ship deadweight. The cargo related data comprises cargo type and cargo capacity.

The step S102 comprises constructing a shipping schedule related nine-intersection models based on the shipping route related data.

The step S103 comprises determining at least two target ships based on the transport request information, the shipping schedule related nine-intersection model, the cargo related data, and ship related data.

The step S104 comprises sending instruction information to the at least two target ships, wherein the instruction information is configured to control the at least two target ships to transport cargo from a departure port to a destination port.

Compared with the prior art, in the embodiment of the present disclosure, the shipping data from different shipping companies are obtained and categorized based on preset information categories to obtain the shipping route related data, the ship related data, and the cargo related data, thus achieving mixed and unified processing of shipping data from different shipping companies. Then, the shipping schedule related nine-intersection model is constructed, and determining the at least two target ships transporting the cargo based on the transport request information, the shipping schedule related nine-intersection model, the cargo related data, and the ship related data. The instruction information is sent to the at least two target ships to realized consolidation of the cargo on the at least two target ships. The cargo is transported from the departure port to the destination port by at least one of the target ships, which achieves consolidation for different shipping companies, saves operating costs for shipping companies, and improves their efficiency. Further, through consolidated transportation, multiple shipping companies can share transportation vessels and other facilities, helping small shipping companies overcome the problem of insufficient transportation capacity, jointly bear logistics costs, avoid empty waste of freight facilities and containers, and improve resource utilization efficiency. Shipping companies can reduce the number of vessel trips and lower the risk of traffic accidents through consolidated transportation. Consolidated transportation can reduce the number of trucks or ships operate, reduce fuel consumption and carbon emissions, and help promote sustainable development and green water logistics.

Furthermore, based on the shipping schedule related nine-intersection model, the topological relationship between routes can be determined. The advantage of this model is that it can analyze a single route of each of the companies and simultaneously analyze the time windows and topological relationships of multiple routes for multi-route consolidation, thereby improving the efficiency of consolidation for shipping companies. This not only saves transportation costs but also solves the problem of insufficient transportation capacity.

The calculation method is simple and the computational complexity is small, which can improve the generation efficiency of consolidation plans.

In an embodiment of the present disclosure, the way to obtain shipping data of different shipping companies in step S101 is to query the official websites, the annual reports, and the sustainability reports, etc., of the Mediterranean Shipping Company, the Maersk, the CMA CGM Group, the Orient Overseas Container Line Limited, and the Ocean Network Express Pte. Ltd., the Hapag-Lloyd, the YangMing Marine transport corp., the EVERGREEN MARINE CORP., the WAN HAI LINES LTD., the Hyundai Merchant Marine, the Z Factor, the Pacific International Lines, the SITC International Holdings Co., Ltd., the KMTC e-Brochure, and collecting shipping data such as schedules, routes, fleets, voyages, and cargo throughput of the shipping companies.

Among them, the preset information categories in step S101 comprise flight category, vessel category, and cargo flow category.

Among them, the shipping route related data specifically refers to:

Compi:{SLᵢⱼ:{Shᵢⱼₖ:(Portᵢⱼₖ₁,Tᵢⱼₖ₁),(Portᵢⱼₖ₂,Tᵢⱼₖ₂), . . . ,(Portᵢⱼₖₙ,Tᵢⱼₖₙ)}},

where, Compᵢ represents shipping company i, {SLᵢⱼ}represents the set of routes operated by shipping company i, SLᵢⱼ represents the j-th route operated by shipping company i, and {Shᵢⱼₖ}represents the set of ships operated by shipping company i on the j-th route, which is the fleets, Shᵢⱼₖ represents the k-th vessel operated by shipping company i on the j-th route.

(Portᵢⱼₖ₁, Tijk1),(Portᵢⱼₖ₂,Tᵢⱼₖ₂), . . . , (Portᵢⱼₖₙ,Tᵢⱼₖₙ) represent the ports where the k-th vessel operated by shipping company i on the j-th route stops sequentially, where Portᵢⱼₖ₁ represents the port of departure, Tᵢⱼₖ₁ represents the department time, Portᵢⱼₖₙ represents the destination port, Tᵢⱼₖₙ represents the arrival time at the destination port, Portᵢⱼₖₙ₂ represents the stopping port, Tᵢⱼₖ₂ represents the arrival time at the stopping port.

Specifically, the ship identification code is the Maritime Mobile Service Identify (MMSI), the ship related data is:

Shᵢⱼₖ:{MMSIᵢⱼₖ,Deadweightᵢⱼₖ,CargoTypeᵢⱼₖ}

where, MMSIᵢⱼₖ represents the MMSI of the k-th vessel operated by shipping company i on the j-th route, Deadweightᵢⱼₖ represents the deadweight of the k-th vessel operated by shipping company i on the j-th route, CargoTypeᵢⱼₖ represents the ship cargo type of the k-th vessel operated by shipping company i on the j-th route.

The cargo related data is:

Cargoᵢ:{Cargoᵢⱼ:(Cargoᵢⱼ₁,Cargoᵢⱼ₂, . . . ,Cargoᵢⱼₘ)}

where, Cargo; represents the cargo flow of shipping company i, Cargoᵢⱼ represents the cargo flow of shipping company i on route j, Cargoᵢⱼₘ represents the cargo flow of the m-th cargo type for shipping company i on route j.

In some embodiments of the present disclosure, the shipping schedule related nine-intersection model comprises nine-intersection model of route and nine-intersection model of time. The nine-intersection model of route comprises a cargo type nine-intersection model.

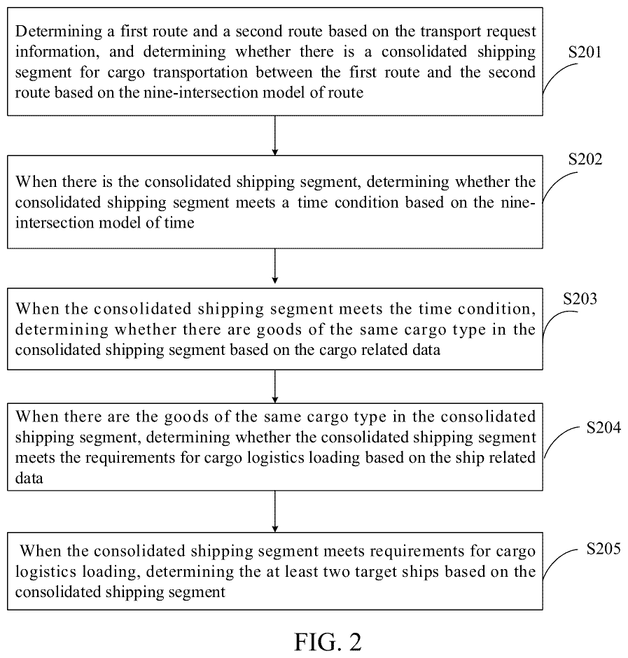

As shown in FIG. 2, the step S103 comprises steps S201-S205.

The step S201 comprises determining a first route and a second route based on the transport request information, and determining whether there is a consolidated shipping segment for cargo transportation between the first route and the second route based on the nine-intersection model of route.

The step S202 comprises when there is the consolidated shipping segment, determining whether the consolidated shipping segment meets the time condition based on the nine-intersection model of time.

The step S203 comprises when the consolidated shipping segment meets a time condition, determining whether there are the goods of the same cargo type in the consolidated shipping segment based on the cargo related data.

The step S204 comprises when there are the goods of the same cargo type in the consolidated shipping segment, determining whether the consolidated shipping segment meets the requirements for cargo logistics loading based on the ship related data.

The step S205 comprises when the consolidated shipping segment meets requirements for cargo logistics loading, determining the at least two target ships based on the consolidated shipping segment.

In this embodiment of the present disclosure, after determining whether there is a consolidated shipping segment between the first route and second route through the nine-intersection model of route, consolidation is not directly carried out in that consolidated shipping segment. Instead, time conditions, cargo type, and cargo flow loading requirements are considered. Through multi-dimensional considerations, the rationality and accuracy of consolidation in consolidated shipping segments were improved, thereby improving the operational efficiency of shipping enterprises.

In this embodiment of the present disclosure, the nine-intersection model of route R₉(SLᵢⱼ,SL_{pq}) is:

$$\{ \begin{matrix}{Port}_{ij 1} {∩ Port}_{pq 1} {Port}_{ij 1} ⋂ \partial {Port}_{pq} {Port}_{ij 1} ⋂ {Port}_{pqn} \\ \partial {Port}_{ij} {∩ Port}_{pq 1} \partial {Port}_{ij} ∩ \partial {Port}_{pq} \partial {Port}_{ij} {∩ Port}_{pqn} \\ {Port}_{ijn} {∩ Port}_{pq 1} {Port}_{ijn} ∩ \partial {Port}_{pq} {Port}_{ijn} {∩ Port}_{pqn}\end{matrix} \}$$

where, Portᵢⱼ₁ represents the departure port of route SLᵢⱼ, ∂Portᵢⱼ represents the intermediate stopping port of route SLᵢⱼ, Portᵢⱼₙ represents the destination port of route SLᵢⱼ. Port_{pq1} represents the departure port of route SL_{pq}, ∂Port_{pq} represents the stopping port of route SL_{pq}, Port_{pqn} represents the destination port of the SL_{pq} route.

In this embodiment of the present disclosure, the nine-intersection model of time R₉(Tᵢⱼ,T_{pq}) is:

$${R}_{9} ( {T}_{ij} , {T}_{pq} ) = \{ \begin{matrix}{T}_{ij 1} ∩ {T}_{pq 1} {T}_{ij 1} ∩ \partial {T}_{pq} {T}_{ij 1} ∩ {T}_{pqn} \\ \partial {T}_{ij} ∩ {T}_{pq 1} \partial {T}_{ij} ∩ \partial {T}_{pq} \partial {T}_{ij} ∩ {T}_{pqn} \\ {T}_{ijn} ∩ {T}_{pq 1} {T}_{ijn} ∩ \partial {T}_{pq} {T}_{ijn} ∩ {T}_{pqn}\end{matrix} \}$$

where, Tᵢⱼ₁ represents the department time of the operating fleet of route SLᵢⱼ, ∂Tᵢⱼ represents the stopping time at the intermediate port of the operating fleet of route SLᵢⱼ, Tᵢⱼₙ represents the final port stop time of the operating fleet of route SLᵢⱼ. T_{pq1} represents the departure time of the operating fleet of route SL_{pq}, and ∂T_{pq} represents the stopping time of the operating fleet of route SL_{pq} at the intermediate port, T_{pqn} represents the final port stop time of the operating fleet on route SL_{pq}.

In an embodiment of the present disclosure, the specific way to determine whether there are goods of the same cargo type in the consolidated shipping segment in step S203 is to determine whether there is an intersection in the cargo logistics of the consolidated shipping segment, which is defined as:

$$\begin{matrix}R ( {Cargo}_{ij} , {Cargo}_{pq} ) = {Cargo}_{ij} {∩ Cargo}_{pq} \\ = ( {Cargo}_{ij 1} , {Cargo}_{ij 2} , … , {Cargo}_{ijm} ) ∩ \\ ( {Cargo}_{pq 1} , {Cargo}_{pq 2} , … , {Cargo}_{pqm} )\end{matrix}$$

When R(Cargoᵢⱼ, Cargo_{pq}) is not 0, it is considered that there is cargo that can be consolidated on the SLᵢⱼ and SL_{pq} routes, that is, there are goods of the same cargo type.

In some embodiments of the present disclosure, the first route comprises a first departure port and a first destination port, and the second route comprises a second departure port and a second destination port. That is, neither the first route nor the second route has a stopping port.

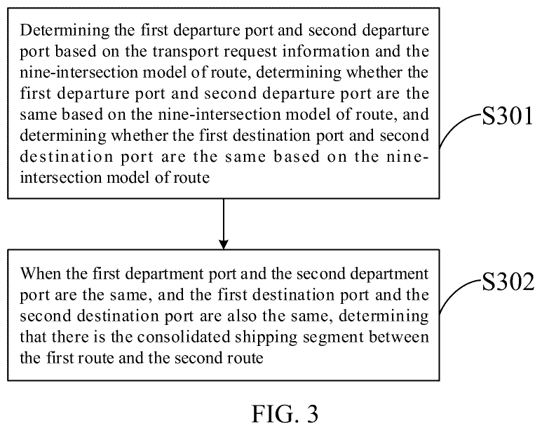

As shown in FIG. 3, the step S201 comprises steps S301-S302.

The step S301 comprises determining the first departure port and second departure port based on the transport request information and the nine-intersection model of route, determining whether the first departure port and second departure port are the same based on the nine-intersection model of route, and determining whether the first destination port and second destination port are the same based on the nine-intersection model of route.

The step S302 comprises when the first department port and the second department port are the same, and the first destination port and the second destination port are also the same, determining that there is the consolidated shipping segment between the first route and the second route.

That is, when Portᵢⱼ₁∩Port_{pq1}=1 and Portᵢⱼₙ∩Port_{pqn}=1 in the nine-intersection model of route, the departure port and the destination port of route SLᵢⱼ and route SL_{pq} intersect, it is considered that SLᵢⱼ and SL_{pq} have a consolidated shipping segment, the consolidated shipping segment is: from the first department port to the first destination port, or from the second department port to the second destination port.

In some other embodiments of the present disclosure, the first route comprises the first departure port, the first destination port, and at least one first stopping port, the second route comprises the second departure port, the second destination port, and at least one second stopping port.

The at least one first stopping port comprises one or more first stopping ports, and the at least one second stopping port comprises one or more second stopping ports.

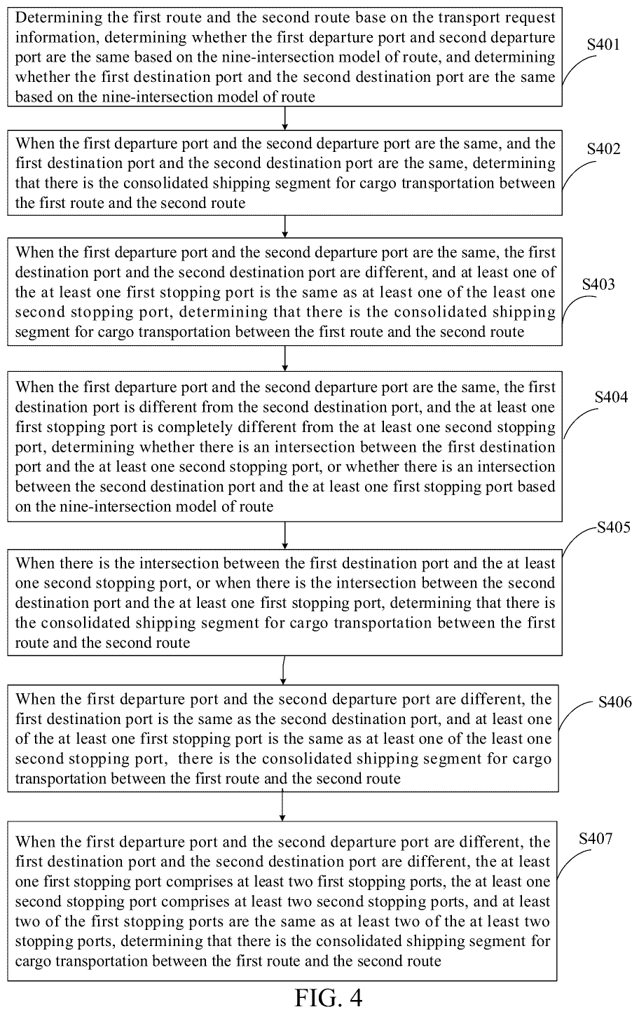

As shown in FIG. 4, the step S201 comprises steps S401-S407.

The step S401 comprises determining the first route and the second route base on the transport request information, determining whether the first departure port and second departure port are the same based on the nine-intersection model of route, and determining whether the first destination port and the second destination port are the same based on the nine-intersection model of route.

The step S402 comprises when the first departure port and the second departure port are the same, and the first destination port and the second destination port are the same, determining that there is the consolidated shipping segment for cargo transportation between the first route and the second route.

The step S403 comprises when the first departure port and the second departure port are the same, the first destination port and the second destination port are different, and at least one of the at least one first stopping port is the same as at least one of the least one second stopping port, determining that there is the consolidated shipping segment for cargo transportation between the first route and the second route.

The step S404 comprises when the first departure port and the second departure port are the same, the first destination port is different from the second destination port, and the at least one first stopping port is completely different from the at least one second stopping port, determining whether there is an intersection between the first destination port and the at least one second stopping port, or whether there is an intersection between the second destination port and the at least one first stopping port based on the nine-intersection model of route.

The step S405 comprises: when there is the intersection between the first destination port and the at least one second stopping port, or when there is the intersection between the second destination port and the at least one first stopping port, determining that there is the consolidated shipping segment for cargo transportation between the first route and the second route.

The step S406 comprises when the first departure port and the second departure port are different, the first destination port is the same as the second destination port, and at least one of the at least one first stopping port is the same as at least one of the least one second stopping port, there is the consolidated shipping segment for cargo transportation between the first route and the second route.

The step S407 comprises: when the first departure port and the second departure port are different, the first destination port and the second destination port are different, the at least one first stopping port comprises at least two first stopping ports, the at least one second stopping port comprises at least two second stopping ports, and at least two of the first stopping ports are the same as at least two of the at least two stopping ports, determining that there is the consolidated shipping segment for cargo transportation between the first route and the second route.

It should be understood that in the step S402, the first departure port and the second departure port are the same, and the first destination port is the same as the second destination port, which comprises three situations, specifically:

The first situation is that the first departure port and the second departure port are the same, the first destination port is the same as the second destination port, and each first stopping port is exactly the same as each second stopping port, that is:

Portᵢⱼ₁∩Port_{pq1}=1 and Portᵢⱼₙ∩Port_{pqn}=1,

and,

∂Portᵢⱼ≠0 and ∂Port_{pq}≠0 and ∂Portᵢⱼ=∂Port_{pq}

In this situation, the consolidated shipping segment is the entire segment of the first route or the entire segment of the second route. That is, the route can be interrupted and only partial segments can be consolidated. For example: consolidation between the departure port and the at least one stopping port, or consolidation between at least two stopping ports (i.e., when the at least one stopping port comprises at least two stopping ports), or consolidation between at least one stooping port and destination ports.

The second situation is that the first departure port and the second departure port are the same, the first destination port is the same as the second destination port, but the at least one first stopping port and the at least one second stopping port are completely different, that is:

Portᵢⱼ₁∩Port_{pq1}=1 and Portᵢⱼₙ∩Port_{pqn}=1,

and,

∂Portᵢⱼ≠0 and ∂Port_{pq}≠0 and ∂Portᵢⱼ∩∂Port_{pq}=0

In this situation, the consolidated shipping segment is only configured for consolidation between the departure port and the destination port.

The third situation is that the first departure port and the second departure port are the same, the first destination port is the same as the second destination port, and at least one of the first stopping ports is the same as at least one of the second stopping port (i.e., one first stopping port is the same as the one second stopping port, at least two first stopping ports are the same as the at least two second stopping ports, one first stopping port is the same as one of the second stopping ports, one second stopping port is the same as one of the first stopping ports, the first stopping ports are partially the same as the second stopping ports, the second stopping ports are partially the same as the first stopping ports). That is:

Portᵢⱼ₁∩Port_{pq1}=1 and Portᵢⱼₙ∩Port_{pqn}=1,

and,

∂Portᵢⱼ≠0 and ∂Port_{pq}≠0 and ∂Portᵢⱼ∩∂Port_{pq}=1

In this situation, for the at least one same stopping port, consolidation can be carried out between the departure port and the stopping port, as well as between the stopping port and the destination port.

Where, in step S403, the first departure port and second departure port are the same, the first destination port is different from the second destination port. At least one of the at least one first stopping port is the same as at least one of the at least one second stopping port, which comprises two situations, specifically:

The first situation is that the first departure port and the second departure port are the same, the first destination port is different from the second destination port, at least one of the at least one first stopping port is the same as at least one of the at least one second stopping port, and there is an intersection between the first destination port and at least one second stopping port, or there is an intersection between the second destination port and at least one first stopping port, i.e.:

Portᵢⱼ₁∩Port_{pq1}=1 and Portᵢⱼ∩Port_{pqn}≠1,

and,

∂Portᵢⱼ≠0 and ∂Port_{pq}≠0

and ∂Portᵢⱼ∩∂Port_{pq}=1,

and,

Portᵢⱼₙ∩∂Port_{pq}=1 or Port_{pqn}∩∂Portᵢⱼ=1

In this situation, consolidation can be carried out between the departure port and the at least one stopping port, as well as between the at least one stopping port of one of the two routes and the destination port of the other one of the two routes.

The second situation is that the first departure port and the second departure port are the same, the first destination port is different from the second destination port, at least one of the art least one first stopping port is the same as at least one of at least one second stopping port, and the first destination Port does not intersect with at least one second stop port, and there is no intersection between the second destination port and at least one first stop port, i.e.:

Portᵢⱼ₁∩Port_{pq1}=1 and Portᵢⱼₙ∩Port_{pqn}≠1,

and,

∂Portᵢⱼ≠0 and ∂Port_{pq}≠0 and ∂Portᵢⱼ∩∂Port_{pq}=1

In this situation, it is possible to combine the departure port and stopping ports of the two routes for transportation.

Among them, step S405 can be described as:

Portᵢⱼ₁∩Port_{pq1}=1 and Portᵢⱼₙ∩Port_{pqn}≠1,

and,

∂Portᵢⱼ≠0 and ∂Port_{pq}≠0 and ∂Portᵢⱼ∩∂Port_{pq}≠1,

and,

Portᵢⱼₙ∩∂Port_{pq}=1 or Port_{pqn}∩∂Portᵢⱼ=1,

Then, consolidation can be carried out between the departure ports and the destination ports that intersect of the two routes.

Among them, step S406 can be described as:

Portᵢⱼ₁∩Port_{pq1}≠1 and Portᵢⱼₙ∩Port_{pqn}=1,

and,

∂Portᵢⱼ≠0 and ∂Port_{pq}≠0 and ∂Portᵢⱼ∩∂Port_{pq}=1,

and,

Portᵢⱼₙ∩∂Port_{pq}≠1 or Port_{pqn}∩∂Portᵢⱼ≠1,

Then, partial consolidation will be carried out between the same stopping port and destination port in both routes.

Specifically, the first departure port and second departure port in step S407 are different, the first destination port is different from the second destination port. Therefore, when there is the consolidated shipping segment, at least two first stopping ports and at least two second stopping ports must be provide, and at least two of the at least two first stopping ports are the same as at least two of at least two second stopping ports (i.e., two or more than two first stopping ports are the same as two or more than two second stopping ports, more than two second stopping ports are partially the same as the two first stopping ports, more than two first stopping ports are partially the same as the two second stopping ports, and more than two first stopping ports are partially the same as more than two second stopping ports), which comprises two situations, specifically:

The first situation is that the destination port of one route does not intersect with the stopping ports of another route, that is:

Portᵢⱼ₁∩Port_{pq1}≠1 and Portᵢⱼₙ∩Port_{pqn}≠1,

and,

∂Portᵢⱼ≠0 and ∂Port_{pq}≠0 and ∂Portᵢⱼₙ∩∂Port_{pq}=1,

and,

Portᵢⱼ∩∂Port_{pq}≠1 and Port_{pqn}∩∂Portᵢⱼ≠1,

In this situation, partial consolidation can be carried out between the same stopping ports of the two routes.

The second situation is that the destination port of one route intersects with one of the stopping ports of another route, that is:

Portᵢⱼ₁∩Port_{pq1}≠1 and Portᵢⱼₙ∩Port_{pqn}≠1,

and,

∂Portᵢⱼ≠0 and ∂Port_{pq}≠0 and ∂Portᵢⱼ∩∂Port_{pq}=1,

and,

Portᵢⱼ∩∂Port_{pq}=1 or Port_{pqn}∩∂Portᵢⱼ=1,

In this situation, consolidation can be carried out between partially identical stopping ports, as well as between partially identical stopping ports and destination ports.

In summary, in the above ten situations, both routes have a consolidated shipping segment.

In some embodiments of the present disclosure, the consolidated shipping segment comprises a departure port for consolidated shipment and an arrival port for consolidated shipment.

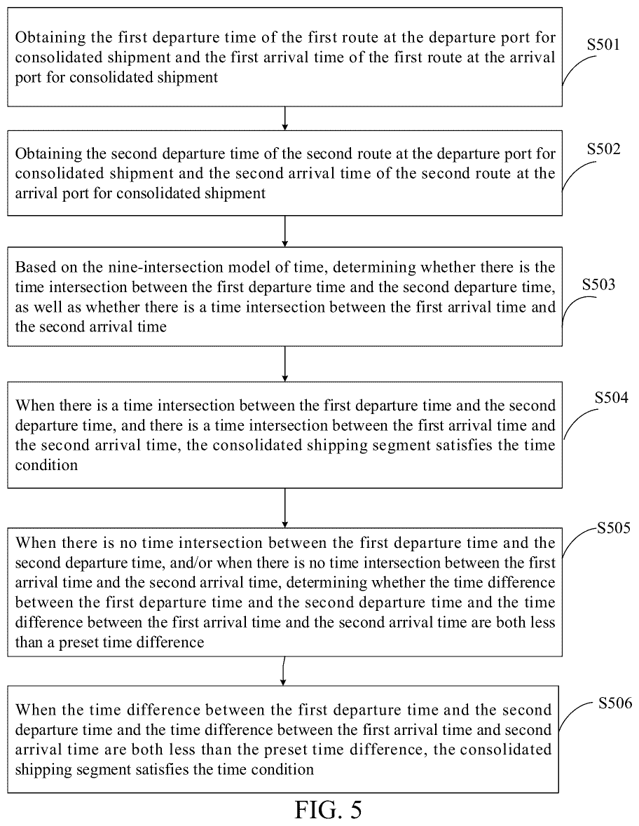

As shown in FIG. 5, the step S202 comprises steps S501-S506.

The step S501 comprises obtaining the first departure time of the first route at the departure port for consolidated shipment and the first arrival time of the first route at the arrival port for consolidated shipment.

The step S502 comprises obtaining the second departure time of the second route at the departure port for consolidated shipment and the second arrival time of the second route at the arrival port for consolidated shipment.

The step S503 comprises based on the nine-intersection model of time, determining whether there is the time intersection between the first departure time and the second departure time, as well as whether there is a time intersection between the first arrival time and the second arrival time.

The step S504 comprises when there is a time intersection between the first departure time and the second departure time, and there is a time intersection between the first arrival time and the second arrival time, the consolidated shipping segment satisfies the time condition.

The step S505 comprises when there is no time intersection between the first departure time and the second departure time, and/or when there is no time intersection between the first arrival time and the second arrival time, determining whether the time difference between the first departure time and the second departure time and the time difference between the first arrival time and the second arrival time are both less than a preset time difference.

The step S506 comprises when the time difference between the first departure time and the second departure time and the time difference between the first arrival time and second arrival time are both less than the preset time difference, the consolidated shipping segment satisfies the time condition.

It should be noted that the preset time difference should meet the time agreed upon in the cargo transportation contract.

The embodiments of the present disclosure can avoid technical problems caused by forced consolidation, which may result in the inability to deliver cargo according to the agreed time in the contract, by setting time conditions. While carrying out consolidation, it ensures that the transportation time meets the agreed time in the contract.

In some embodiments of the present disclosure, the consolidated shipping segment comprises a first vessel in the first route and a second vessel in the second route.

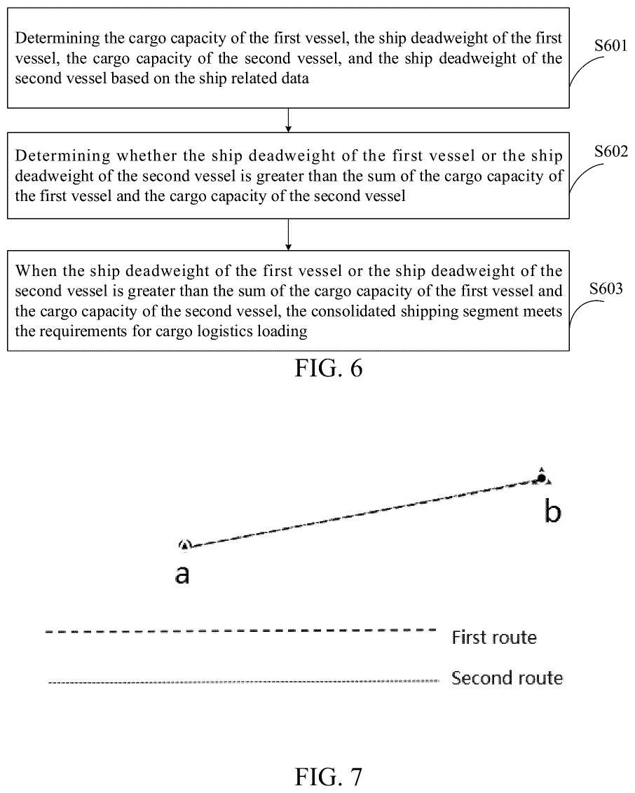

As shown in FIG. 6, the step S204 comprises steps S601-S603.

The step S601 comprises determining the cargo capacity of the first vessel, the ship deadweight of the first vessel, the cargo capacity of the second vessel, and the ship deadweight of the second vessel based on the ship related data.

The step S602 comprises determining whether the ship deadweight of the first vessel or the ship deadweight of the second vessel is greater than the sum of the cargo capacity of the first vessel and the cargo capacity of the second vessel.

The step S603 comprises when the ship deadweight of the first vessel or the ship deadweight of the second vessel is greater than the sum of the cargo capacity of the first vessel and the cargo capacity of the second vessel, the consolidated shipping segment meets the requirements for cargo logistics loading.

By following steps S601˜603, it is ensured that fewer vessels can meet the loading requirements of cargo, avoiding ineffective consolidation and improving the reliability and accuracy of consolidation.

The shipping route related data of the shipping company A is {A:{A1, A2, A10}}. A1={ship A1_1:(a, t_{AA1a_1}), (b, t_{AA1b_1}); ship A1_2:(a, t_{AA1a_2}), (b, t_{AA1b_2})}. A2={ship A2_1:(a, t_{AA2a_1}), (c, t_{AA2c_1}), (b, t_{AA2b_1}), (d, t_{AA2d_1}); ship A2_2: (a, t_{AA2a_2}), (c, t_{AA2c_2}), (b, t_{AA2b_2}), (d, t_{AA2d_2})}. A3={ship A3_1:(a, t_{AA3a_1}), (b, t_{AA3b_1}), (d, t_{AA3d_1}); ship A3_2:(a, t_{AA3a_2}), (b, t_{AA3b_2}), (d, t_{AA3d_2})}. A4={ship A4_1:(a, t_{AA4a_1}), (b, t_{AA4b_1}), (d, t_{AA4d_1}); ship A4_2:(a, t_{AA4a_2}), (b, t_{AA4b_2}), (d, t_{AA4d_2})}. A5={ship A5_1:(a, t_{AA5a_1}), (b, t_{AA5b_1}), (c, t_{AA5c_1}); ship A5_2:(a, t_{AA5a_2}), (b, t_{AA5b_2}), (c, t_{AA5c_2})}. A6={shipA6_1:(a, t_{AA6a_1}), (c, t_{AA6e_1}), (e, t_{AA6e_1}), (f, t_{AA6f_1}); ship A6_2:(a, t_{AA6a_2}), (c, t_{AA6e_2}), (e, t_{AA6e_2}), (f, t_{AA6f_2})}. A7={ship A71:(a, t_{AA7a_1}), (c, t_{AA7c_1}), (d, t_{AA7d_1}); ship A7_2:(a, t_{AA7a_2}), (c, t_{AA7c_2}), (d, t_{AA7d_2})}. A8={shipA8_1:(a, t_{AA8a_1}), (b, t_{AA8b_1}), (d, t_{AA8d_1}); ship A8_2:(a, t_{AA8a_2}), (b, t_{AA8b_2}), (d, t_{AA8d_2})}. A9={shipA9_1:(a, t_{AA9a_1}), (b, t_{AA9b_1}), (c, t_{AA9c_1}), (d, t_{AA9d_1}), (e, t_{AA9e_1}), (f, t_{AA9f_1}); ship A9_2:(a, t_{AA9a_2}), (b, t_{AA9b_2}), (c, t_{AA9c_2}), (d, t_{AA9d_2}), (e, t_{AA9e_2}), (f, t_{AA9f_2})}. A10={ship A10_1:(a, t_{AA10a_1}), (b, t_{AA10b_1}), (c, t_{AA10c_1}), (d, t_{AA10d_1}), (e, t_{AA10e_1}); ship A10_2:(a, t_{AA10a_2}), (b, t_{AA10b_2}), (c, t_{AA10c_2}), (d, t_{AA10d_2}), (e, t_{AA10e_2})}.

The shipping route related data of the shipping company B is {B:{B1, B2, B10}}. B1={ship B1_1:(a, t_{BB1a_1}), (b, t_{BB1b_1}); ship B1_2:(a, t_{BB1a_2}), (b, t_{BB1a_2})}. B2={ship B2_1:(a, t_{BB2a_1}), (c, t_{BB2c_1}), (b, t_{BB2b_1}), (d, t_{BB2d_1}); ship B2_2:(a, t_{BB2a_2}), (c, t_{BB2c_2}), (b, t_{BB2b_2}), (d, t_{BB2d_2})}. B3={ship B3_1:(a, t_{BB3a_1}), (c, t_{BB3c_1}), (d, t_{BB3d_1}); ship B3_2:(a, t_{BB3a_2}), (c, t_{BB3c_2}), (d, t_{BB3d_2})}. B4={ship B4_1:(a, t_{BB4a_1}), (c, t_{BB4c_1}), (b, t_{BB4b_1}), (d, t_{BB4d_1}); ship B4_2:(a, t_{BB4a_2}), (c, t_{BB4c_2}), (b, t_{BB4b_2}), (d, t_{BB4d_2})}. B5={ship B5_1:(a, t_{BB5a_1}), (b, t_{BB5b_1}), (d, t_{BB5d_1}); ship B5_2:(a, t_{BB5a_2}), (b, t_{BB5b_2}), (d, t_{BB5d_2})}. B6={ship B6_1:(a, t_{BB6a_1}), (b, t_{BB6b_1}), (c, t_{BB6c_1}), (d, t_{BB6d_1}); ship B6_2:(a, t_{BB6a_2}), (b, t_{BB6b_2}), (c, t_{BB6c_2}), (d, t_{BB6d_2})}. B7={ship B7_1:(a, t_{BB7a_1}), (b, t_{BB7b_1}), (c, t_{BB7c_1}); ship B7_2:(a, t_{BB7a_2}), (b, t_{BB7b_2}), (c, t_{BB7c_2})}. B8={ship B8_1:(e, t_{BB8e_1}), (c, t_{BB8c_1}), (b, t_{BB8b_1}), (d, t_{BB8d_1}); ship B8_2:(e, t_{BB8e_2}), (c, t_{BB8c_2}), (b, t_{BB8b_2}), (d, t_{BB8d_2})}. B9={ship B9_1:(k, t_{BB9k_1}), (h, t_{BB9h_1}), (i, t_{BB9i_1}), (c, t_{BB9c_1}), (d, t_{BB9d_1}), (e, t_{BB9e_1}), (j, t_{BB9j_1});ship B9_2:(k, t_{BB9k_2}), (h, t_{BB9h_2}), (i, t_{BB9i_2}), (c, t_{BB9c_2}), (d, t_{BB9d_2}), (e, t_{BB9e_2}), (j, t_{BB9j_2})}. B10={ship B10_1:(f, t_{BB10f_1}), (g, t_{BB10g_1}), (c, t_{BB10c_1}), (d, t_{BB10d_1});ship B10_2:f, t_{BB10f_2}), (g, t_{BB10g_2}), (c, t_{BB10c_2}), (d, t_{BB10d_2})}.

The shipping related data of the shipping company A is: {A1_1,A1_2,A2_1,A2_2,A3_1,A3_2,A4_1,A4_2,A5_1,A5_2,A6_1,A6_2,A7_1,A7_2,A8_1,A8_2,A9_1,A9_2,A10_1,A10_2}.

A1_1={00A1_1, 200000 tons, dry bulk}. A1_2={00A1_2, 200000 tons, tanker}. A2_1={00A2_1, 200000 tons, dry bulk}. A2_2={00A2_2, 200000 tons, tanker}. A3_1={00A3_1, 200000 tons, dry bulk}. A3_2={00A3_2, 200000 tons, tanker}. A4_1={00A4_1, 200000 tons, dry bulk}. A4_2={00A4_2, 200000 tons, tanker}. A5_1={00A5_1, 200000 tons, dry bulk}. A5_2={00A5_2, 200000 tons, tanker}. A6_1={00A6_1, 200000 tons, dry bulk}. A6_2={00A6_2, 200000 tons, tanker}. A7_1={00A7_1, 200000 tons, dry bulk}. A7_2={00A7_2, 200000 tons, tanker}. A8_1={00A8_1, 200000 tons, dry bulk}. A8_2={00A8_2, 200000 tons, tanker}. A9_1={00A9_1, 200000 tons, dry bulk}. A9_2={00A9_2, 200000 tons, tanker}. A10_1={00A10_1, 200000 tons, dry bulk}. A10_2={00A10_2, 200000 tons, tanker}.

The shipping route related data of the shipping company B is: {B1_1,B1_2,B2_1,B2_2,B3_1,B3_2,B4_1,B4_2,B5_1,B5_2,B6_1,B6_2,B7_1,B7_2,B8_1,B8_2,B9_1,B9_2,B10_1,B10_2}. B1_1={00B1_1, 1200000 tons, dry bulk}. B1_2={00B1_2, 1200000 tons, tanker}. B2_1={00B2_1, 1200000 tons, dry bulk}. B2_2={00B2_2, 1200000 tons, tanker}. B3_1={00B3_1, 1200000 tons, dry bulk}. B3_2={00B3_2, 1200000 tons, tanker}. B4_1={00B4_1, 1200000 tons, dry bulk}. B4_2={00B4_2, 1200000 tons, tanker}. B5_1={00B5_1, 1200000 tons, dry bulk}. B5_2={00B1_2, 1200000 tons, tanker}. B6_1={00B6_1, 1200000 tons, dry bulk}. B6_2={00B6_2, 1200000 tons, tanker}. B7_1={00B7_1, 1200000 tons, dry bulk}. B7_2={00B7_2, 1200000 tons, tanker}. B8_1={00B8_1, 1200000 tons, dry bulk}. B8_2={00B8_2, 1200000 tons, tanker}. B9_1={00B9_1, 1200000 tons, dry bulk}. B9_2={00B9_2, 1200000 tons, tanker}. B10_1={00B10_1, 1200000 tons, dry bulk}. B10_2={00B10_2, 1200000 tons, tanker}.

A specific embodiment of the present disclosure is shown in FIG. 7.

The cargo transportation request received by the shipping company A is from Ports a->b. The departure time is Jul. 29, 2023-Aug. 1, 2023, the arrival time is August 14, the cargo type is dry bulk, and the cargo volume is 60000 tons (hereafter route A1).

The cargo transportation request received by the shipping company B is from Port: a->b, the departure time is Jul. 28, 2023-Aug. 1, 2023, the arrival time is August 14, the cargo type is dry bulk, and the cargo volume is 90000 tons (hereafter the second route B1).

According to the shipping route data of the shipping companies A and B, and based on the nine-intersection model of route, it is obtained that the departure port of the first route A1 is the same as that of the second route B1, which is Port a, and the destination port of the first routes A1 is the same as that of the second route B1, which is Port b, so there is the consolidated shipping segment between Port a and Port b. Based on the nine-intersection model of time, it is calculated whether there is an intersection between the departure time of Port a and the arrival time of Port b in the first route A1 and the second route B1. It is obtained that there is the intersection in the departure time and the arrival time of the first route A1 and the second route B1 is the same, which meets the time condition.

The cargo type of the shipping company A on the first route A1 is the same as the cargo type of the shipping company B on the second route B1, that is, there is a crossover of the cargo. The tonnage of a dry bulk ship of the shipping company A on the first route A1 is 200 thousand, which meet a total cargo volume of the cargo requested to be transported by the shipping company A on the first route A1 and the cargo requested to be transported by the shipping company B on the second route B1. The tonnage of the dry bulk ship of the shipping company B on the second route B1 is 120 thousand, which cannot meet the total cargo volume of the cargo requested to be transported by the shipping company A on the first route A1 and the cargo requested to be transported by the shipping company B on the second route B1. Therefore, the target ship associated with the first route A1 (i. e., the dry bulk ship) is used for cargo transportation. After use, the fuel cost, ship cost, and crew cost required for the operation of the second route B1 are saved, while reducing the transportation cost per tonnage of the cargo on the first route A1, thereby improving transportation efficiency and saving emissions.

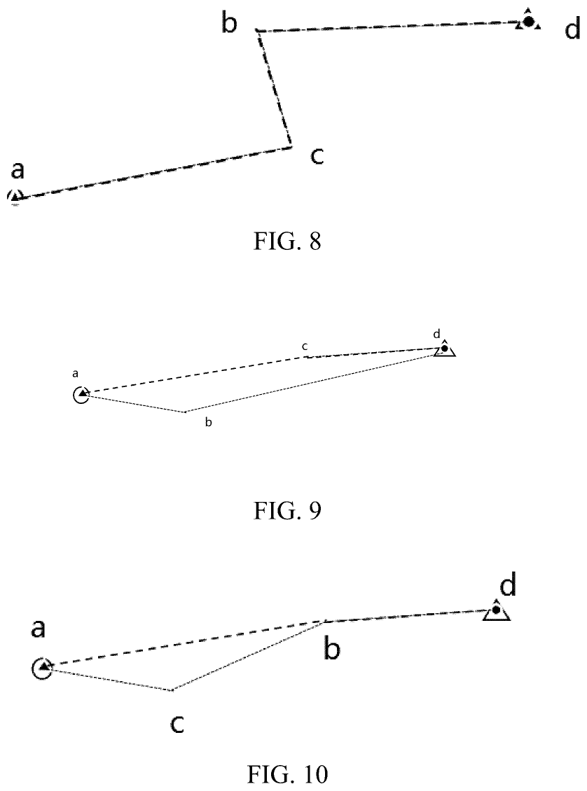

A specific embodiment of the present disclosure is shown in FIG. 8.

The cargo transportation request received by the shipping company A is from Ports a-c-b-d, the departure time is Jul. 28, 2023-Aug. 1, 2023, the arrival time at Port c is August 14, the arrival time at Port b is August 21, the final stop time is September 24, the cargo type is dry bulk, and the cargo volume is 60000 tons (hereafter the first route A2).

The cargo transportation request received by the shipping company B is from Ports a-c-b-d, the departure time is Jul. 28, 2023-Aug. 1, 2023, the arrival time at Port c is August 14, the arrival time at Port b is August 21, the final stop time is September 24, the cargo type is the dry bulk, and the cargo volume is 90000 tons (hereafter the second route B2).

When it is determined that the departure port of the transported cargo is Port a, the destination port is Port d, and the stopping ports are c and d according to the received transport request information, the first route A2 and the second route B2 are determined based on the transport request information and the nine-intersection model of route according to the shipping route related data of the shipping companies A and B.

The departure port, the destination port, and the stopping port of the first route A2 are the same as that of the second route B2, and there is the consolidated shipping segment. The departure time, the stopping time, and the final stop time of the first route A2 are the same as that of the second route B2, which meets the time conditions of the nine-intersection model of route.

The tonnage of the dry bulk ship of the shipping company A on the route A2 is 200 thousand, which meet the total cargo volume of the cargo requested to be transported by the shipping company A on the route A2 and the cargo requested to be transported by the shipping company B on the route B2. The tonnage of the dry bulk ship of the shipping company B on the route B2 is 120 thousand, which cannot meet the total cargo volume of the cargo requested to be transported by the shipping company A on the route A2 and the cargo requested to be transported by the shipping company B on the route B2. Therefore, the target ship associated with route A2 (i. e., the dry bulk ship) is used for cargo transportation.

After use, the fuel cost, ship cost, and crew cost required for the operation of the route B2 are saved, while reducing the transportation cost per tonnage of the cargo on the route A2, thereby improving transportation efficiency and saving emissions.

A specific embodiment of the present disclosure is shown in FIG. 9.

The cargo transportation request received by the shipping company A is from Ports a-b-d, the departure time is Jul. 29, 2023-Aug. 1, 2023, the final stop time is September 24, the cargo type is the dry bulk, and the cargo volume is 60000 tons (hereafter the first route A3).

The cargo transportation request received by the shipping company B is from Ports a-c-d, the departure time is Jul. 28, 2023-Aug. 1, 2023, the final stop time is September 24, the cargo type is dry bulk, and the cargo volume is 90000 tons (hereafter the second route B3).

When it is determined that the departure port of the transported cargo is Port a, the destination port is Port d, and the stopping ports are Port b and Port c according to the received transport request information, the first route A3 and the second route B3 are determined based on the transport request information.

The departure port and the destination port of the first route A3 are the same as that of the second route B3. Although the stopping ports of the first route A2 are different from that of the second route B3, the transported cargo on the first route A3 is allowed to be transported together with the transported cargo on the second route B3 from the departure port thereof to the destination port thereof. Further, the departure time and the final stop time of the first route A3 are the same as that of the second route B3, which meet the time condition.

The tonnage of the dry bulk ship of the shipping company A on the route A3 is 200 thousand, which meet the total cargo volume of the cargo requested to be transported by the shipping company A on the route A3 and the cargo requested to be transported by the shipping company B on the route B3. The tonnage of the dry bulk ship of the shipping company B on the route B3 is 120 thousand, which cannot meet the total cargo volume of the cargo requested to be transported by the shipping company A on the route A3 and the cargo requested to be transported by the shipping company B on the route B3. Therefore, the target ship associated with route A3 (i. e., the dry bulk ship) is used for cargo transportation.

After use, the fuel cost, ship cost, and crew cost required for the operation of the route B3 are saved, while reducing the transportation cost per tonnage of the cargo on the route A4, thereby improving transportation efficiency and saving emissions.

A specific embodiment of this disclosure is shown in FIG. 10:

The cargo transportation request received by the shipping company A is from Port a-b-d, the departure time is Jul. 29, 2023-Aug. 1, 2023, the arrival time at Port b is August 21, the final stop time is September 24, the cargo type is dry bulk, and the cargo volume is 60000 tons (hereafter the first route A4).

The cargo transportation request received by the shipping company B is from port a-c-b-d, the departure time is Jul. 28, 2023-Aug. 1, 2023, the arrival time at Port c is August 14, the arrival time at Port b is August 21, the final stop time is September 24, the cargo type is the dry bulk, and the cargo volume is 90000 tons (hereafter the second route B4).

When it is determined that the departure port of the transported cargo is Port a, the destination port is Port d, and the stopping ports are Port b, Port c and Port b according to the received transport request information, the first route A4 and the second route B4 are determined based on the transport request information and the nine-intersection model of route.

The departure port and the destination port of the first route A4 are the same as that of the second route B4. One of the stopping ports of the second route B4 is the same as the stopping port of the first route A4. Then, there are consolidated shipping segments between Port a and Port d and between Port b and Port d. A difference between of the departure time of the first route A4 at Port a and the departure time of the second route B4 at Port a is very small, and the arrival time at Ports b and d of the first route A4 and the second route B4 are the same, which meets the time condition.

The tonnage of the dry bulk ship of the shipping company A on the route A4 is 200 thousand, which meet the total cargo volume of the cargo requested to be transported by the shipping company A on the route A4 and the cargo requested to be transported by the shipping company B on the route B4. The tonnage of the dry bulk ship of the shipping company B on the route B4 is 120 thousand, which cannot meet the total cargo volume of the cargo requested to be transported by the shipping company A on the route A4 and the cargo requested to be transported by the shipping company B on the route B4. Therefore, the target ship associated with route A4 (i. e., the dry bulk ship) is used for cargo transportation.

After use, the fuel cost, ship cost, and crew cost required for the operation of the route B4 are saved, while reducing the transportation cost per tonnage of the cargo on the route A4, thereby improving transportation efficiency and saving emissions.

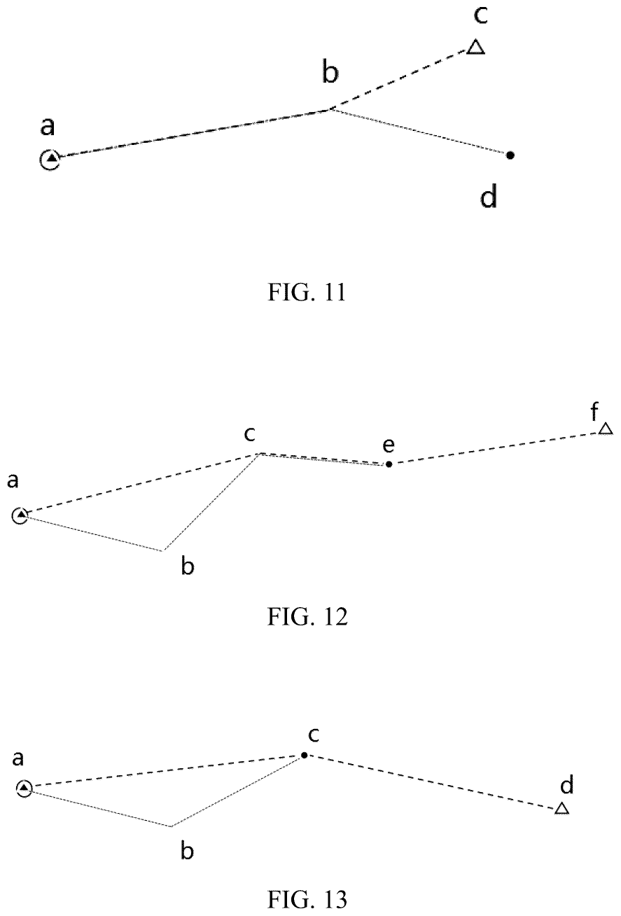

A specific embodiment of the present disclosure is shown in FIG. 11.

The cargo transportation request received by the shipping company A is from the Ports a-b-c, the departure time is Jul. 29, 2023-Aug. 1, 2023, the arrival time at Port b is August 14, the cargo type is dry bulk, and the cargo volume is 60000 tons (hereafter the first route A5).

The cargo transportation request received by the shipping company B is from the Ports a-b-d, the departure time is Jul. 28, 2023-Aug. 1, 2023, the arrival time at Port b is August 14, the cargo type is dry bulk, and the cargo volume is 90000 tons (hereafter the second router B5).

When it is determined that the departure port of the transported cargo is Port a, the destination ports are respectively Port c and Port d, and the stopping port is Port b according to the received transport request information, the first route A5 and the second route B5 are determined based on the transport request information and the nine-intersection model of route.

The departure port of the first route A5 is the same as that of the second route B5. The destination port of the first route A5 is different from that of the second route B5. The stopping port of the second route B5 is the same as the stopping port of the first route A5. Then, there is a consolidated shipping segments between Ports a and Port b. A difference between of the departure time of the first route A5 at Port a and the departure time of the second route B5 at Port a is very small, and the arrival time at Port b of the first route A5 and the arrival time at Port b of the second route B4 are the same, which meets the time condition.

The tonnage of the dry bulk ship of the shipping company A on the route A5 is 200 thousand, which meet the total cargo volume of the cargo requested to be transported by the shipping company A on the route A5 and the cargo requested to be transported by the shipping company B on the route B5. The tonnage of the dry bulk ship of the shipping company B on the route B5 is 120 thousand, which cannot meet the total cargo volume of the cargo requested to be transported by the shipping company A on the route A5 and the cargo requested to be transported by the shipping company B on the route B5. Therefore, the target ship associated with route A5 (i. e., the dry bulk ship) is used for cargo transportation from the Port a to Port b.

After use, the fuel cost, ship cost, and crew cost required for the operation of the route B5 are saved, while reducing the transportation cost per tonnage of the cargo on the route A5, thereby improving transportation efficiency and saving emissions.

In a specific embodiment of the present disclosure, as shown in FIG. 12,

The cargo transportation request received by the shipping company A is from the Ports a-c-e-f, the departure time is Jul. 29, 2023-Aug. 1, 2023, the arrival time at Port c is August 21, the arrival time at Port e: is September 1, the final stop time is September 10, the cargo type is dry bulk, and the cargo volume is 60000 tons (hereafter route A6)

The cargo transportation request received by the shipping company B is from the Ports a-b-c-e, the departure time is Jul. 28, 2023-Aug. 1, 2023, the arrival time at Port b is August 14, the arrival time at Port c is August 21, the final stop time at Port e is September 3, the cargo type is dry bulk, and the cargo volume is 90000 tons (hereafter route B6).

When it is determined that the departure port of the transported cargo is Port a, the destination ports are respectively Port f and Port e, the stopping ports of the first route A6 are Ports c and e, and the stopping ports of the second route B6 are Ports b and c according to the received transport request information, the first route A6 and the second route B6 are determined based on the transport request information and the nine-intersection model of route.

The departure port of the first route A6 is the same as that of the second route B6. The destination port of the first route A6 is different from that of the second route B6. One of the stopping ports of the second route B6 is the same as one of the stopping ports of the first route A6. The destination port of the second route B6 is one of the stopping ports of the first route A6. Then, there is a consolidated shipping segment between Ports a and Port c, a consolidated shipping segment between Port c and Port e, and a consolidated shipping segment between Ports a and Port e. Furthermore, a difference between of the departure time of the first route A6 at Port a and the departure time of the second route B6 at Port a is very small, and the arrival time at Port c of the first route A6 and the arrival time at Port c of the second route B6 are the same, which meets the time condition. However, the arrival time of the first route A6 at Port e is inconsistent with the arrival time of the second route B6 at Port e, and a time difference thereof is greater than one day. Therefore, the consolidated shipping segment for cargo transportation is from Port a to Port c.

The tonnage of the dry bulk ship of the shipping company A on the route A6 is 200 thousand, which meet the total cargo volume of the cargo requested to be transported by the shipping company A on the route A6 and the cargo requested to be transported by the shipping company B on the route B6. The tonnage of the dry bulk ship of the shipping company B on the route B6 is 120 thousand, which cannot meet the total cargo volume of the cargo requested to be transported by the shipping company A on the route A6 and the cargo requested to be transported by the shipping company B on the route B6. Therefore, the target ship associated with route A6 (i. e., the dry bulk ship) is used for cargo transportation from Port a to Port c.

After use, the fuel cost, ship cost, and crew cost required for the operation of the route B6 are saved, while reducing the transportation cost per tonnage of the cargo on the route A6, thereby improving transportation efficiency and saving emissions.

A specific embodiment of the present disclosure is shown in FIG. 13.

The cargo transportation request received by the shipping company A is from the Ports a-c-d, the departure time is Jul. 29, 2023-Aug. 1, 2023, the arrival time at Port c is August 14, the final stop time is September 24, the cargo type is dry bulk, and the cargo volume is 60000 tons (hereafter the first route A7).

The cargo transportation request received by the shipping company B is from the Ports a-b-c, the departure time is Jul. 28, 2023-Aug. 1, 2023, the arrival time at Port b is August 14, the final stop time at Port c is August 21, the cargo type is dry bulk, and the cargo volume is 90000 tons (hereafter the second route B7).

When it is determined that the departure port of the transported cargo is Port a, the destination ports are Port d and Port c, and the stopping ports are Port b and Port c according to the received transport request information, the first route A7 and the second route B7 are determined based on the transport request information and the nine-intersection model of route.

The departure port of the first route A7 is the same as that of the second route B7. The destination port of the first route A7 is different from that of the second route B7. However, the destination port of the second route B7 is the stopping port of the first route A7. Thus, there is a consolidated shipping segment between Port a and Port c. Even a difference between the departure time of the first route A7 at Port a and the departure time of the second route B7 at Port a is very small, a difference between of the arrival time of the first route A7 at port c and the arrival time of the second route B7 at port c is large, which does not meet the time condition. Therefore, the cargo transported on the first route A7 cannot be transported together with the cargo transported on the second route B7.

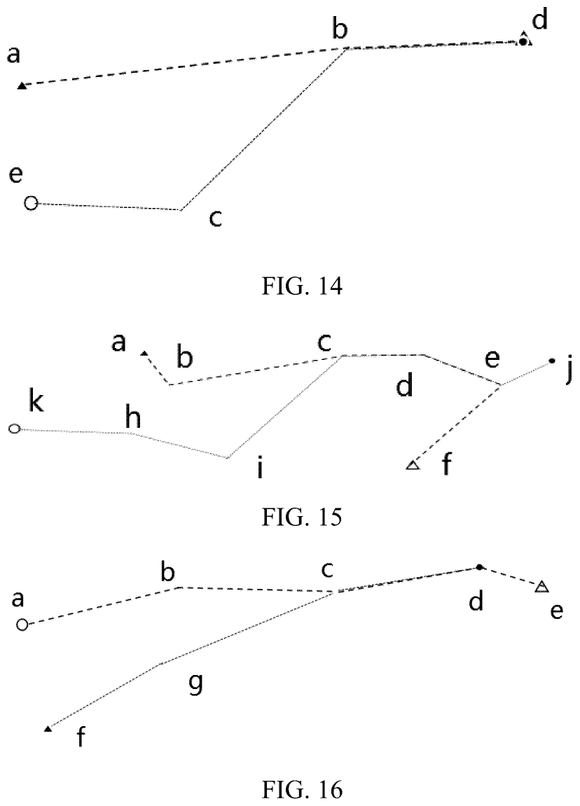

A specific embodiment of the present disclosure is shown in FIG. 14.

The cargo transportation request received by the shipping company A is from the Ports a-b-d, the departure time is Jul. 29, 2023-Aug. 1, 2023, the arrival time at Port b is August 21, the final stop time is September 2, the cargo type is dry bulk, and the cargo volume is 60000 tons (hereafter the first route A8).

The cargo transportation request received by the shipping company B is from the Ports e-c-b-d, the departure time is Jul. 28, 2023-Aug. 1, 2023, the arrival time at Port c is August 14, the arrival time at Port b is August 21, the final stop time is September 2, the cargo type is dry bulk, and the cargo volume is 90000 tons (hereafter the second route B8).

When it is determined that the departure ports of the transported cargo are Port a and Port e, the destination port is Port d, and the stopping ports are Port b, Port c and Port b according to the received transport request information, the first route A8 and the second route B8 are determined based on the transport request information and the nine-intersection model of route.

The departure port of the first route A8 is different from that of the second route B4. The destination port of the first route A8 is the same as that of the second route B8. One of the stopping ports of the second route B8 is the same as the stopping port of the first route A8. Then, there is a consolidated shipping segment between Port b and Port d. The arrival time of the first route A8 at Port b and d is the same as the arrival time of the second route B8 at Port b and d, which meets the time condition.

The tonnage of the dry bulk ship of the shipping company A on the route A8 is 200 thousand, which meet the total cargo volume of the cargo requested to be transported by the shipping company A on the route A8 and the cargo requested to be transported by the shipping company B on the route B8. The tonnage of the dry bulk ship of the shipping company B on the route B8 is 120 thousand, which cannot meet the total cargo volume of the cargo requested to be transported by the shipping company A on the route A8 and the cargo requested to be transported by the shipping company B on the route B8. Therefore, the target ship associated with route A8 (i. e., the dry bulk ship) is used for cargo transportation from Port b to Port d.

After use, the fuel cost, ship cost, and crew cost required for the operation of the route B8 are saved, while reducing the transportation cost per tonnage of the cargo on the route A8, thereby improving transportation efficiency and saving emissions.

A specific embodiment of the present disclosure is shown in FIG. 15.

The cargo transportation request received by the shipping company A is from the Ports a-b-c-d-e-f, the departure time is Jul. 29, 2023-Aug. 1, 2023, the arrival time at Port c is August 14, the arrival time at Port d is August 21, the arrival time at Port e is September 11, the final stop time is September 24, the cargo type is dry bulk, and the cargo volume is 60000 tons (hereafter the first route A9).

The cargo transportation request received by the shipping company B is from the Ports k-h-i-c-d-e-j, the departure time is Jul. 28, 2023-Aug. 1, 2023, the arrival time at Port c is August 14, the arrival time at Port d is August 21, the arrival time at Port e is September 11, the final stop time is September 17, the cargo type is dry bulk, and the cargo volume is 90000 tons (hereafter the second route B9).

When it is determined that the departure ports of the transported cargo are respectively Port a and Port k, the destination ports are respectively Port f and Port j, and the stopping ports are Ports b, c, d, e and Ports c and h, i, c, d, e according to the received transport request information, the first route A9 and the second route B9 are determined based on the transport request information and the nine-intersection model of route.

The departure port and the destination port of the first route A9 are different from that of the second route B9. Three of the stopping ports of the second route B9 is the same as three of the stopping ports of the first route A9. Then, there is a consolidated shipping segment from Port c-d-e. The arrival time of the first route A9 at ports c, d, and e is the same as the arrival time of the second route B9 at ports c, d, and e, which meets the time condition.

The tonnage of the dry bulk ship of the shipping company A on the route A9 is 200 thousand, which meet the total cargo volume of the cargo requested to be transported by the shipping company A on the route A9 and the cargo requested to be transported by the shipping company B on the route B9. The tonnage of the dry bulk ship of the shipping company B on the route B9 is 120 thousand, which cannot meet the total cargo volume of the cargo requested to be transported by the shipping company A on the route A9 and the cargo requested to be transported by the shipping company B on the route B9. Therefore, the target ship associated with route A9 (i. e., the dry bulk ship) is used for cargo transportation from Ports c-d-e. After use, the fuel cost, ship cost, and crew cost required for the operation of the route B9 are saved, while reducing the transportation cost per tonnage of the cargo on the route A9, thereby improving transportation efficiency and saving emissions.

In some embodiments of the present disclosure, as shown in FIG. 16,

The cargo transportation request received by the shipping company A is from the Ports a-b-c-d-e, the departure time is Jul. 29, 2023-Aug. 1, 2023, the arrival time at Port b is August 14, the arrival time at Port c is August 21, the arrival time at Port d is September 11, the final stop time is September 24, the cargo type is dry bulk, and the cargo volume is 60000 tons (hereafter the first route A10)

The cargo transportation request received by the shipping company A is from the Ports f-g-c-d, the departure time is Jul. 31, 2023-Aug. 3, 2023, the arrival time at Port c is August 14, the final stop time is August 21, the cargo type is dry bulk, and the cargo volume is 90000 tons (hereafter the second route B10.

When it is determined that the departure ports of the transported cargo are respectively Port a and Port f, the destination ports are respectively Port c and Port d, and the stopping ports are Ports b, c, and d and Ports g and c according to the received transport request information, the first route A10 and the second route B10 are determined based on the transport request information and the nine-intersection model of route.

The departure port and the destination port of the first route A10 are different from that of the second route B10. However, the destination port of the second route B10 is the same as the stopping port of the first route A10, and the stopping port c of the second route B10 is the same as the stopping port c of the first route A10. Therefore, there is a consolidated shipping segment from Port c to Port d. The arrival time of the first route A10 at Ports c and d is the same as the arrival time of the second route B10 at Ports c and d, which meets the time condition.

The tonnage of the dry bulk ship of the shipping company A on the first route A10 is 200 thousand, which meet the total cargo volume of the cargo requested to be transported by the shipping company A on the first route A10 and the cargo requested to be transported by the shipping company B on the second route B10. The tonnage of the dry bulk ship of the shipping company B on the second route B10 is 120 thousand, which cannot meet the total cargo volume of the cargo requested to be transported by the shipping company A on the first route A10 and the cargo requested to be transported by the shipping company B on the second route B10. Therefore, the target ship associated with route A10 (i. e., the dry bulk ship) is used for cargo transportation from Ports c-d. After use, the fuel cost, ship cost, and crew cost required for the operation of the second route B10 are saved, while reducing the transportation cost per tonnage of the cargo on the first route A10, thereby improving transportation efficiency and saving emissions.

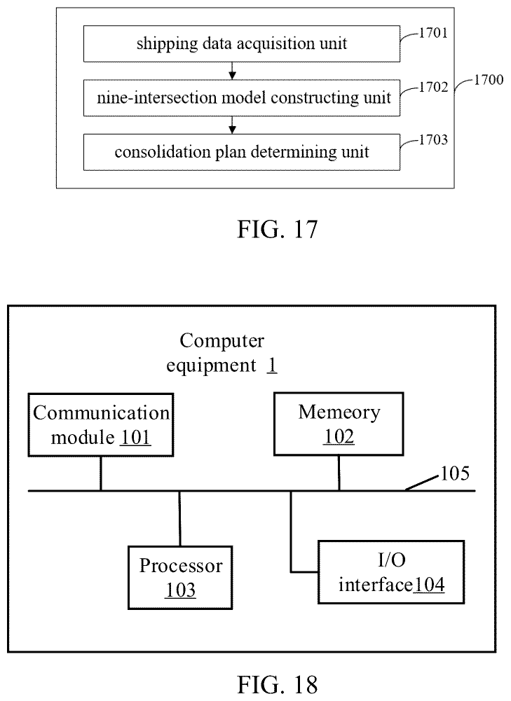

In order to better implement the cargo transportation method in the present disclosure, based on the cargo transportation method, correspondingly, the present disclosure also provides a cargo transportation device. As shown in FIG. 17, the cargo transportation device 1700 comprises a shipping data acquisition unit 1701, a nine-intersection model constructing unit 1702, and a consolidation plan determining unit 1703.

The shipping data acquisition unit 1701 is configured to obtain shipping data from different shipping companies, classify the shipping data based on preset information categories, and obtain shipping route related data, ship related data, and cargo related data.

The shipping route related data comprises shipping company code, route code, route departure port, route stopping port, route destination port, departure time, arrival time at route stopping port, and destination port arrival time. The ship related data comprises ship identification code, ship cargo type, and ship deadweight. The cargo related data comprises cargo type and cargo capacity.

The nine-intersection model constructing unit 1702 is configured to construct a shipping schedule related nine-intersection model based on the shipping route related data.

The consolidation plan determining unit 1703 is configured to determine a consolidation plan for shipping data based on the shipping schedule related nine-intersection model, the cargo related data, and the ship related data, and carry out consolidation based on the consolidation plan.

The cargo transportation device 1700 provided in the above embodiment can achieve the technical solution described in the above cargo transportation method. The specific implementation principles of the above modules or units can be found in the corresponding content of the above cargo transportation method embodiments, and will not be repeated here.

As shown in FIG. 18, FIG. 18 is a structural schematic diagram of the computer equipment according to one embodiment of the present disclosure. As shown in FIG. 18, the computer equipment 1 may be a server. For example, the computer equipment 1 may be a central server, an edge server, or a local server of a local data center. The computer equipment 1 may include a communication module 101, a memory 102, a processor 103, an input/output (I/O) interface 104, and a bus 105. The processor 103 is coupled to the communication interface 101, the memory 102, and the I/O interface 104 through the bus 105.

The present disclosure also provides a corresponding equipment for water transportation consolidation 1800. The equipment for water transportation and consolidation 1800 comprises a processor 1801, a memory 1802, and a display 1803. FIG. 18 only shows some components of the equipment for water transportation and consolidation 1800, but it should be understood that it is not required to implement all the shown components, and more or fewer components can be implemented as an alternative.

The processor 1801 may be a Central Processing Unit (CPU) in some embodiments, a microprocessor or other data processing chip configured to run program code stored in the memory 1802 or process data, such as the method for water transportation and consolidation in the present disclosure.

The communication module 101 may include a wired communication module and/or a wireless communication module. The wired communication module includes one or more wired communication structures such as a universal serial bus (USB), a controller area network (CAN). The wireless communication module includes one or more wireless communication structures such as wireless fidelity (Wi-Fi), BLUETOOTH (BT), mobile communication network, frequency modulation (FM), near field communication technology (NFC), infrared technology (IR), etc.

The memory 102 includes one or more random access memories (RAM) and one or more non-volatile memories (NVM). The random access memory is allowed to be directly read and written by the processor 103, is configured to store executable programs (such as machine instructions) of an operating system or other running programs, and is configured to store user and application data. The random access memory includes a static random access memory (SRAM), a dynamic random access memory (DRAM), a synchronous dynamic random access memory (SDRAM), a double data rate synchronous dynamic random access memory (DDR SDRAM), etc.

The non-volatile memory is further configured to store executable programs and user and application data, etc., and may be pre-loaded into the random access memory for direct reading and writing by the processor 103. The non-volatile memory may include a disk storage device and a flash memory.

The memory 102 is configured to store one or more computer programs. The one or more computer programs are configured to be executed by the processor 103. The one or more computer programs include instructions. When the instructions are executed by the processor 103, a text clustering method or a contract clause retrieval method executed on the computer equipment 1 is implemented.

In other embodiments, the computer equipment 1 further includes an external memory interface configured for connecting an external memory to expand a storage capacity of the computer equipment 1.

The processor 103 includes one or more processing units. For example, the processor 103 includes an application processor (AP), a modem processor, a graphics processing unit (GPU), an image signal processor (ISP), a controller, a video codec, a digital signal processor (DSP), a baseband processor, and/or a neural-network processing unit (NPU). Different processing units may be independent devices or integrated into one or more processors.

The processor 103 has computing and control capabilities. For example, the processor 103 is configured to execute the computer program stored in the memory 102.

The I/O interface 104 is configured to provide a channel for user input or output.

For example, the I/O interface 104 is configured to connect various input and output devices, such as a mouse, keyboard, touch device, display screen, etc., so that the user is able to input information or visualize information.

The bus 105 is at least configured to provide a channel for mutual communication between the communication module 101, the memory 102, the processor 103, and the I/O interface 104 in the computer equipment 1.

It is understood that the structure illustrated in the embodiment of the present disclosure does not constitute a specific limitation on the computer equipment 1. In other embodiments of the present disclosure, the computer equipment 1 may include more or fewer components than that shown in the figure. Alternatively, some of the components may be combined, separated, or have different arrangements. The illustrated components may be implemented in hardware, software, or a combination of the software and the hardware.

The embodiment of the present disclosure further provides a computer-readable storage medium. The computer program is stored therein, and the computer program includes program instructions. When the program instructions are executed, the cargo transportation method in the above-mentioned embodiments of the present disclosure is implemented.

The computer-readable storage medium may be the memory of the computer equipment described in the above-mentioned embodiments, such as the hard disk or the memory of the computer equipment. The computer-readable storage medium may also be an external storage device of the computer equipment, such as a plug-in hard disk equipped on the computer equipment, a smart memory card (SMC), a secure digital (SD) card, a flash card, etc.

In some embodiments, the computer-readable storage medium may include a program storage area and a data storage area. The program storage area stores the operating system, programs required for at least one function, etc. The data storage area stores data created according to the use of the electronic device, etc.

In the above-mentioned embodiments, descriptions of each embodiment have their own emphasis. For parts that are not described in detail or recorded in one embodiment, reference may be made to related descriptions of other embodiments.

Those of ordinary skill in the art can realize that units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solutions. Those of ordinary skill in the art may implement the described functionality using different methods for each particular application, and such implementations should not be considered beyond the scope of the present disclosure.

In the embodiments provided in the present disclosure, it should be understood that the disclosed apparatus/network device and method may be implemented in other manners. For example, the apparatus/network device of the embodiments described above are merely illustrative, and the division of the modules or units is merely a kind of logical function division, and there may be other division manners in actual implementation. For instance, a plurality of units or components may be combined or may be integrated into another system, or some features may be ignored or not performed. In addition, the displayed or discussed mutual coupling, direct coupling, or communication connection may be indirect coupling or communication connection through some interfaces, devices or units, and may be realized in electrical, mechanical, or other forms.

The units described as separate parts may or may not be physically separate, and parts of the units may or may not be physical units. That is, the parts of the units may be located in one position, or may be distributed on a plurality of network units. Some or all of the units may be selected according to actual needs to achieve the purpose of the solution of the embodiments.

The above-mentioned embodiments are only used to illustrate technical solutions of the present disclosure, but not to limit the present disclosure. Although the present disclosure has been described in detail with reference to the foregoing embodiments. It should be understood that those of ordinary skill in the art are still able to modify the technical solutions described in the foregoing embodiments, or equivalently replace some of the technical features in the foregoing embodiments, and these modifications or replacements do not make the essence of the corresponding technical solutions deviate from spirit and scope of the technical solutions of the embodiment of the present disclosure, which shall be included in the protection scope of the present disclosure.

What is claimed is:

1. A cargo transportation method, applied to a computer equipment, wherein the computer equipment is at least in communication with electronic devices, each of electronic devices is disposed on a corresponding target ship; wherein the cargo transportation method comprising steps:
receiving transport request information, wherein the transport request information at least comprises departure port information and destination port information;
obtaining shipping data from different shipping companies, classifying the shipping data based on preset information categories, and obtaining shipping route related data, ship related data, and cargo related data; wherein the shipping route related data comprises shipping company code, route code, route departure port, route stopping ports, route destination port, departure time at departure port, arrival time at route stopping ports, and destination port arrival time; the ship related data comprises ship identification code, ship cargo type, and ship deadweight; the cargo related data comprises cargo type and cargo capacity;
constructing a shipping schedule related nine-intersection model based on the shipping route related data;
determining at least two target ships based on the transport request information, the shipping schedule related nine-intersection model, the cargo related data, and the ship related data;
sending instruction information to the at least two target ships, wherein the instruction information is configured to control the at least two target ships to transport cargo from a departure port to a destination port;
the shipping schedule related nine-intersection model comprises nine-intersection model of route and nine-intersection model of time;
the step of determining the at least two target ships based on the transport request information, the shipping schedule related nine-intersection model, the cargo related data, and the ship related data comprises:
determining a first route and a second route based on the transport request information, and determining whether there is a consolidated shipping segment for cargo transportation between the first route and the second route based on the nine-intersection model of route;
when there is the consolidated shipping segment, determining whether the consolidated shipping segment meets a time condition based on the nine-intersection model of time;
when the consolidated shipping segment meets the time condition, determining whether there are goods of the same cargo type in the consolidated shipping segment based on the cargo related data;
when there are the goods of the same cargo type in the consolidated shipping segment, determining whether the consolidated shipping segment meets the requirements for cargo logistics loading based on the ship related data; and
when the consolidated shipping segment meets requirements for cargo logistics loading, determining the at least two target ships based on the consolidated shipping segment
wherein the nine-intersection model of route R₉(SLᵢⱼ, SL_{pq}) is:
$$\{ \begin{matrix}{Port}_{ij 1} {∩ Port}_{pq 1} {Port}_{ij 1} ⋂ \partial {Port}_{pq} {Port}_{ij 1} ⋂ {Port}_{pqn} \\ \partial {Port}_{ij} {∩ Port}_{pq 1} \partial {Port}_{ij} ∩ \partial {Port}_{pq} \partial {Port}_{ij} {∩ Port}_{pqn} \\ {Port}_{ijn} {∩ Port}_{pq 1} {Port}_{ijn} ∩ \partial {Port}_{pq} {Port}_{ijn} {∩ Port}_{pqn}\end{matrix} \}$$
where Portᵢⱼ₁ represents the departure port of route SLᵢⱼ, ∂Portᵢⱼ represents the intermediate stopping ports of route SLᵢⱼ, Portᵢⱼₙ represents the destination port of route SLᵢⱼ; Port_{pq1} represents the departure port of route SL_{pq}, ∂Port_{pq} represents the stopping ports of route SL_{pq}, Port_{pqn} represents the destination port of the SL_{pq} route;
the nine-intersection model of time R_{g} (Tᵢⱼ, T_{pq}) is:
$${R}_{9} ( {T}_{ij} , {T}_{pq} ) = \{ \begin{matrix}{T}_{ij 1} ∩ {T}_{pq 1} {T}_{ij 1} ∩ \partial {T}_{pq} {T}_{ij 1} ∩ {T}_{pqn} \\ \partial {T}_{ij} ∩ {T}_{pq 1} \partial {T}_{ij} ∩ \partial {T}_{pq} \partial {T}_{ij} ∩ {T}_{pqn} \\ {T}_{ijn} ∩ {T}_{pq 1} {T}_{ijn} ∩ \partial {T}_{pq} {T}_{ijn} ∩ {T}_{pqn}\end{matrix} \}$$
where Tᵢⱼ₁ represents the department time of the operating fleet of route SLᵢⱼ, ∂Tᵢⱼ represents the stopping time at each intermediate port of the operating fleet of route SLᵢⱼ, T j represents the final port stop time of the operating fleet of route SLᵢⱼ; T_{pq1} represents the departure time of the operating fleet of route SL_{pq}, and ∂T_{pq} represents the stopping time of the operating fleet of route SL_{pq} at each intermediate port, T_{pqn} represents the final port stop time of the operating fleet on route SL_{pq}.

2. The cargo transportation method according to claim 1, wherein the first route comprises a first departure port and a first destination port, and the second route comprises a second departure port and a second destination port;
the step of determining whether there is the consolidated shipping segment for cargo transportation between the first route and the second route based on the nine-intersection model of route comprises:
determining the first departure port and second departure port based on the transport request information and the nine-intersection model of route, determining whether the first departure port and second departure port are the same based on the nine-intersection model of route, and determining whether the first destination port and second destination port are the same based on the nine-intersection model of route; and
when the first department port and the second department port are the same, and the first destination port and the second destination port are also the same, determining that there is the consolidated shipping segment between the first route and the second route.

3. The cargo transportation method according to claim 1, wherein the first route comprises the first departure port, the first destination port, and at least one first stopping port, the second route comprises the second departure port, the second destination port, and at least one second stopping port;
wherein the at least one first stopping port comprises one or more first stopping ports, and the at least one second stopping port comprises one or more second stopping ports;
the step of determining whether there is the consolidated shipping segment for cargo transportation between the first route and the second route based on the nine-intersection model of route comprises:
determining the first route and the second route base on the transport request information, determining whether the first departure port and second departure port are the same based on the nine-intersection model of route, and determining whether the first destination port and the second destination port are the same based on the nine-intersection model of route;
when the first departure port and the second departure port are the same, and the first destination port and the second destination port are the same, determining that there is the consolidated shipping segment for cargo transportation between the first route and the second route;
when the first departure port and the second departure port are the same, the first destination port and the second destination port are different, and at least one of the at least one first stopping port is the same as at least one of the least one second stopping port, determining that there is the consolidated shipping segment for cargo transportation between the first route and the second route;
when the first departure port and the second departure port are the same, the first destination port is different from the second destination port, and the at least one first stopping port is completely different from the at least one second stopping port, determining whether there is an intersection between the first destination port and the at least one second stopping port, or whether there is an intersection between the second destination port and the at least one first stopping port based on the nine-intersection model of route;
when there is the intersection between the first destination port and the at least one second stopping port, or when there is the intersection between the second destination port and the at least one first stopping port, determining that there is the consolidated shipping segment for cargo transportation between the first route and the second route;
when the first departure port and the second departure port are different, the first destination port is the same as the second destination port, and at least one of the at least one first stopping port is the same as at least one of the least one second stopping port, there is the consolidated shipping segment for cargo transportation between the first route and the second route; and
when the first departure port and the second departure port are different, the first destination port and the second destination port are different, the at least one first stopping port comprises at least two first stopping ports, the at least one second stopping port comprises at least two second stopping ports, and at least two of the first stopping ports are the same as at least two of the at least two stopping ports, determining that there is the consolidated shipping segment for cargo transportation between the first route and the second route.

4. The cargo transportation method according to claim 1, wherein the consolidated shipping segment comprises a departure port for consolidated shipment and an arrival port for consolidated shipment;
the step of determining whether the consolidated shipping segment meets the time condition based on the nine-intersection model of time comprises:
obtaining the first departure time of the first route at the departure port for consolidated shipment and the first arrival time of the first route at the arrival port for consolidated shipment;
obtaining the second departure time of the second route at the departure port for consolidated shipment and the second arrival time of the second route at the arrival port for consolidated shipment;
based on the nine-intersection model of time, determining whether there is a time intersection between the first departure time and the second departure time, as well as whether there is a time intersection between the first arrival time and the second arrival time;
when there is a time intersection between the first departure time and the second departure time, and there is a time intersection between the first arrival time and the second arrival time, the consolidated shipping segment satisfies the time condition;
when there is no time intersection between the first departure time and the second departure time, and/or when there is no time intersection between the first arrival time and the second arrival time, determining whether the time difference between the first departure time and second departure time and the time difference between the first arrival time and the second arrival time are both less than a preset time difference;
when the time difference between the first departure time and the second departure time and the time difference between the first arrival time and the second arrival time are both less than the preset time difference, the consolidated shipping segment satisfies the time condition.

5. The cargo transportation method according to claim 1, wherein the consolidated shipping segment comprises a first vessel in the first route and a second vessel in the second route;
the step of determining whether the consolidated shipping segment meets the requirements for cargo logistics loading based on the ship related data comprises:
determining the cargo capacity of the first vessel, the ship deadweight of the first vessel, the cargo capacity of the second vessel, and the ship deadweight of the second vessel based on the ship related data;
determining whether the ship deadweight of the first vessel or the ship deadweight of the second vessel is greater than the sum of the cargo capacity of the first vessel and the cargo capacity of the second vessel; and
when the ship deadweight of the first vessel or the ship deadweight of the second vessel is greater than the sum of the cargo capacity of the first vessel and the cargo capacity of the second vessel, determining that the consolidated shipping segment meets the requirements for cargo logistics loading.

6. A cargo transportation device, comprising:
a shipping data acquisition unit, which is configured to obtain shipping data from different shipping companies, classify the shipping data based on preset information categories, and obtain shipping route related data, ship related data, and cargo related data; wherein the shipping route related data comprises shipping company code, route code, route departure port, route stopping porta, route destination port, departure time, arrival time at route stopping porta, and destination port arrival time; the ship related data comprises ship identification code, ship cargo type, and ship deadweight; the cargo related data comprises cargo type and cargo capacity;
a nine-intersection model constructing unit, which is configured to construct a shipping schedule related nine-intersection model based on the shipping route related data;
a consolidation plan determining unit, which is configured to determine a consolidation plan for shipping data based on the shipping schedule related nine-intersection model, the cargo related data, and the ship related data, and carry out consolidation based on the consolidation plan;
the shipping schedule related nine-intersection model comprises nine-intersection model of route and nine-intersection model of time;
the method that determining a consolidation plan for shipping data based on the shipping schedule related nine-intersection model, the cargo related data, and the ship related data, and carrying out consolidation based on the consolidation plan comprises:
determining whether there is a consolidated shipping segment between the first route and the second route based on the nine-intersection model of route;
when there is a consolidated shipping segment, determining whether the consolidated shipping segment meets the time condition based on the nine-intersection model of time;
when the consolidated shipping segment meets a time condition, determining whether there are the goods of the same cargo type in the consolidated shipping segment based on the cargo related data;
when there are the goods of the same cargo type in the consolidated shipping segment, determining whether the consolidated shipping segment meets the requirements for cargo logistics loading based on the ship related data;
when the consolidated shipping segment meets requirements for cargo logistics loading, carrying out consolidation in the consolidated shipping segment;
the nine-intersection model of route R_{g}(SLᵢⱼ, SL_{pq}) is:
$$\{ \begin{matrix}{Port}_{ij 1} {∩ Port}_{pq 1} {Port}_{ij 1} ⋂ \partial {Port}_{pq} {Port}_{ij 1} ⋂ {Port}_{pqn} \\ \partial {Port}_{ij} {∩ Port}_{pq 1} \partial {Port}_{ij} ∩ \partial {Port}_{pq} \partial {Port}_{ij} {∩ Port}_{pqn} \\ {Port}_{ijn} {∩ Port}_{pq 1} {Port}_{ijn} ∩ \partial {Port}_{pq} {Port}_{ijn} {∩ Port}_{pqn}\end{matrix} \}$$
where, Portᵢⱼ₁ represents the departure port of route SLᵢⱼ, ∂Portᵢⱼ represents the intermediate stopping ports of route SLᵢⱼ, Portᵢⱼₙ represents the destination port of route SLᵢⱼ; Port_{pq1} represents the departure port of route SL_{pq}, ∂Port_{pq} represents the stopping ports of route SL_{pq}, Port_{pqn} represents the destination port of the SL_{pq} route;
the nine-intersection model of time R₉(Tᵢⱼ, T_{pq}) is:
$${R}_{9} ( {T}_{ij} , {T}_{pq} ) = \{ \begin{matrix}{T}_{ij 1} ∩ {T}_{pq 1} {T}_{ij 1} ∩ \partial {T}_{pq} {T}_{ij 1} ∩ {T}_{pqn} \\ \partial {T}_{ij} ∩ {T}_{pq 1} \partial {T}_{ij} ∩ \partial {T}_{pq} \partial {T}_{ij} ∩ {T}_{pqn} \\ {T}_{ijn} ∩ {T}_{pq 1} {T}_{ijn} ∩ \partial {T}_{pq} {T}_{ijn} ∩ {T}_{pqn}\end{matrix} \}$$
where, Tᵢⱼ₁ represents the department time of the operating fleet of route SLᵢⱼ, ∂Tᵢⱼ represents the stopping time at each intermediate port of the operating fleet of route SLᵢⱼ, Tᵢⱼₙ represents the final port stop time of the operating fleet of route SLᵢⱼ; T_{pq1} represents the departure time of the operating fleet of route SL_{pq}, and ∂T_{pq} represents the stopping time of the operating fleet of route SL_{pq} at each intermediate port, T_{pqn} represents the final port stop time of the operating fleet on route SL_{pq}.

7. A computer equipment, comprising a memory and a processor, wherein the memory is configured to store a program, the processor is coupled with the memory and is configured to execute the program stored in the memory to implement the steps of the cargo transportation method according to claim 1.

8. A computer-readable storage medium, comprising: a program or an instruction stored therein,
wherein the program or the instruction is readable by a computer equipment, and the program or the instruction is executed by a processor of the computer equipment to implement the steps of the cargo transportation method according to claim 1.
